(19) United States
(12) Patent Application Publication
(10) Pub. No.: US 2024/0394905 A1
(43) Pub. Date: Nov. 28, 2024

(54) IMAGE PROCESSING DEVICE AND IMAGE PROCESSING METHOD

(71) Applicant: SONY SEMICONDUCTOR SOLUTIONS CORPORATION, KANAGAWA (JP)

(72) Inventors: AKITO KUWABARA, KANAGAWA (JP); HITOSHI KAI, KANAGAWA (JP); HIROYUKI OZAWA, KANAGAWA (JP)

(21) Appl. No.: 18/262,701

(22) PCT Filed: Jan. 25, 2022
(86) PCT No.: PCT/JP2022/002594

§ 371 Date: Jul. 24, 2023

(30) Foreign Application Priority Data
Feb. 3, 2021 (JP) 2021-015918

(51) Int. Cl. G06T 7/70; G06T 3/40; G06T 5/50; G06T 7/194

(52) U.S. Cl. CPC G06T 7/70; G06T 3/40; G06T 5/50; G06T 7/194; G06T 2207/20224

(57) ABSTRACT

An image processing device according to an embodiment includes: a detection unit (201) that detects a position of an object, included in an input image, in the input image; a generation unit (200) that generates a recognition image having a predetermined resolution and including the object from the input image based on the position detected by the detection unit; and a recognition unit (204) that performs recognition processing of recognizing the object on the recognition image generated by the generation unit.

### FIELD

The present disclosure relates to an image processing device and an image processing method.

### BACKGROUND

An image sensor incorporating a deep neural network (DNN) engine therein has been known.

### CITATION LIST

### Patent Literature

Patent Literature 1: Japanese Patent No. 6633216

### SUMMARY

### Technical Problem

In such an image sensor, in the related art, object recognition processing is performed in an application processor outside the image sensor in a case where an object region to be recognized is clipped from a captured image that has been captured and is subjected to the recognition processing. Alternatively, the object recognition processing is performed by the DNN engine inside the image sensor, and, on the basis of the result thereof, the application processor outside the image sensor instructs the DNN engine inside the image sensor on a clipping range of an object region with respect to the captured image. Thus, a significant frame delay occurs until completion of a series of processes of the object position detection, the clipping of the object region, and the object recognition processing.

The present disclosure provides an image processing device and an image processing method which enable execution of recognition processing at a higher speed.

### Solution to Problem

For solving the problem described above, an image processing device according to one aspect of the present disclosure has a detection unit that detects a position of an object, included in an input image, in the input image; a generation unit that generates a recognition image having a predetermined resolution and including the object from the input image based on the position detected by the detection unit; and a recognition unit that performs recognition processing of recognizing the object on the recognition image generated by the generation unit.

### BRIEF DESCRIPTION OF DRAWINGS

FIG. 1 is a schematic diagram for describing a first image processing method according to an existing technology.

FIG. 2 is a schematic diagram for describing a second image processing method according to the existing technology.

FIG. 3 is a functional block diagram of an example for describing functions of an image sensor configured to execute the second image processing method according to the existing technology.

FIG. 4 is a sequence diagram of an example for describing the second image processing method according to the existing technology.

FIG. 5 is a sequence diagram of an example for describing a third image processing method according to the existing technology.

FIG. 6A is a diagram schematically illustrating a state in the image sensor in processing of each frame in the third image processing method according to the existing technology.

FIG. 6B is a diagram schematically illustrating a state in the image sensor in the processing of each frame in the third image processing method according to the existing technology.

FIG. 6C is a diagram schematically illustrating a state in the image sensor in the processing of each frame in the third image processing method according to the existing technology.

FIG. 7 is a schematic diagram for describing movement prediction according to the existing technology.

FIG. 8 is a diagram illustrating a configuration of an example of an imaging system applicable to each embodiment of the present disclosure.

FIG. 9 is a block diagram illustrating a configuration of an example of an imaging device applicable to each embodiment.

FIG. 10 is a block diagram illustrating a configuration of an example of an image sensor applicable to each embodiment of the present disclosure.

FIG. 11 is a perspective view illustrating an outline of an external configuration example of the image sensor according to each embodiment.

FIG. 12 is a functional block diagram of an example for describing functions of an image sensor according to a first embodiment.

FIG. 13 is a functional block diagram of an example for describing functions of a detection unit according to the first embodiment.

FIG. 14 is a view schematically illustrating an example of a position detection image according to the first embodiment.

FIG. 15 is a sequence diagram of an example for describing processing according to the first embodiment.

FIG. 16 is a functional block diagram of an example for describing functions of an image sensor according to a second embodiment.

FIG. 17 is a functional block diagram of an example for describing functions of a prediction and detection unit according to the second embodiment.

FIG. 18 is a sequence diagram of an example for describing processing according to the second embodiment.

FIG. 19 is a schematic diagram for describing movement prediction according to the second embodiment.

FIG. 20 is a schematic diagram for describing pipeline processing applicable to the second embodiment.

FIG. 21 is a functional block diagram of an example for describing functions of an image sensor according to a third embodiment.

FIG. 22 is a functional block diagram of an example for describing functions of an image sensor according to a fourth embodiment.

Hereinafter, embodiments of the present disclosure will be described in detail with reference to the drawings. Note that the same portions are denoted by the same reference signs in the following embodiment, and a repetitive description thereof will be omitted.

### DESCRIPTION OF EMBODIMENTS

Hereinafter, the embodiments of the present disclosure will be described in the following order.
1. Outline of Present Disclosure
2. Regarding Existing Technology
2-1. First Image Processing Method according to Existing Technology
2-2. Second Image Processing Method according to Existing Technology
2-3. Third Image Processing Method according to Existing Technology
2-4. Movement Prediction according to Existing Technology
3. Configuration Applicable to Each Embodiment of Present Disclosure
4. First Embodiment according to Present Disclosure
4-1. Configuration Example according to First Embodiment
4-2. Processing Example according to First Embodiment
5. Second Embodiment according to Present Disclosure
5-1. Configuration Example according to Second Embodiment
5-2. Processing Example according to Second Embodiment
5-3. Pipeline Processing Applicable to Second Embodiment
6. Third Embodiment according to Present Disclosure
7. Fourth Embodiment according to Present Disclosure

### 1. Outline of Present Disclosure

The present disclosure relates to an image sensor that captures an image of a subject and acquires a captured image, and the image sensor according to the present disclosure includes an imaging unit that performs imaging and a recognition unit that performs object recognition on the basis of the captured image captured by the imaging unit. In the present disclosure, a position of an object to be recognized by the recognition unit on the captured image is detected on the basis of the captured image captured by the imaging unit. On the basis of the detected position, an image including a region corresponding to the object is clipped from the captured image at a resolution that can be supported by the recognition unit, and is output to the recognition unit as a recognition image.

Since such a configuration is adopted, the present disclosure can shorten a delay time (latency) from when imaging is performed and a captured image is acquired to when a recognition result based on the captured image is obtained. Furthermore, the position of the object to be recognized on the image is performed on the basis of a detection image obtained by converting the captured image into an image having a resolution lower than that of the captured image. As a result, a load of the object position detection processing is reduced, and the delay time can be further shortened.

### 2. Regarding Existing Technology

Prior to describing each of the embodiments of the present disclosure, an existing technology related to the technology of the present disclosure will be schematically described in order to facilitate understanding.

### 2-1. First Image Processing Method According to Existing Technology

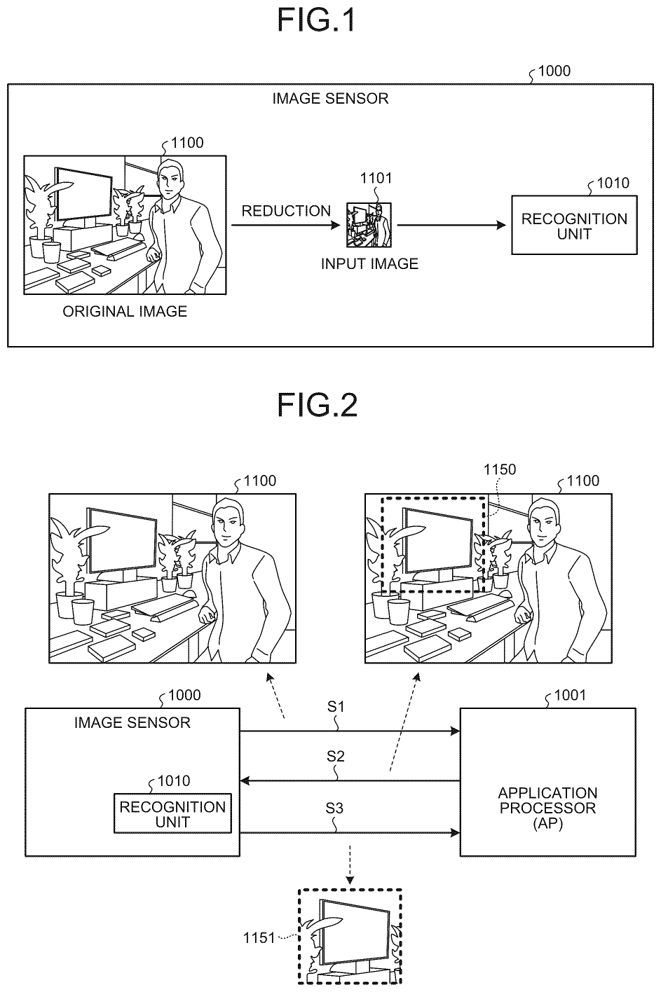

First, a first image processing method according to the existing technology will be described. FIG. 1 is a schematic diagram for describing the first image processing method according to the existing technology. In FIG. 1, an image sensor 1000 includes an imaging unit (not illustrated) and a recognition unit 1010 that uses a captured image 1100 captured by the imaging unit as an original image and recognizes objects included in the captured image 1100. The recognition unit 1010 recognizes the objects included in the captured image using a deep neural network (DNN).

Here, in a case where a recognition device that performs recognition processing using the DNN is incorporated in the image sensor 1000 and used, in general, a resolution (size) of an image that can be supported by the recognition device is limited to a predetermined resolution (for example, 224 pixels×224 pixels) from the viewpoint of cost and the like. Therefore, in a case where an image to be subjected to recognition processing has a high resolution (for example, 4000 pixels×3000 pixels), it is necessary to generate an image with a resolution that can be supported by the recognition device on the basis of the image.

In the example of FIG. 1, the entire captured image 1100 is simply reduced to a resolution that can be supported by the recognition unit 1010 to generate an input image 1101 to be input to the recognition unit 1010 in the image sensor 1000. In the case of the example of FIG. 1, each of the objects included in the captured image 1100 is a low-resolution image, and thus, a recognition rate of each of the objects is low.

### 2-2. Second Image Processing Method According to Existing Technology

Next, a second image processing method according to the existing technology will be described. In the second image processing method and a third image processing method to be described later, an image corresponding to a region including an object to be recognized is clipped from the captured image 1100 to generate an input image to be input to the recognition unit 1010 in order to suppress a decrease in the recognition rate of each of the objects in the first image processing method described above.

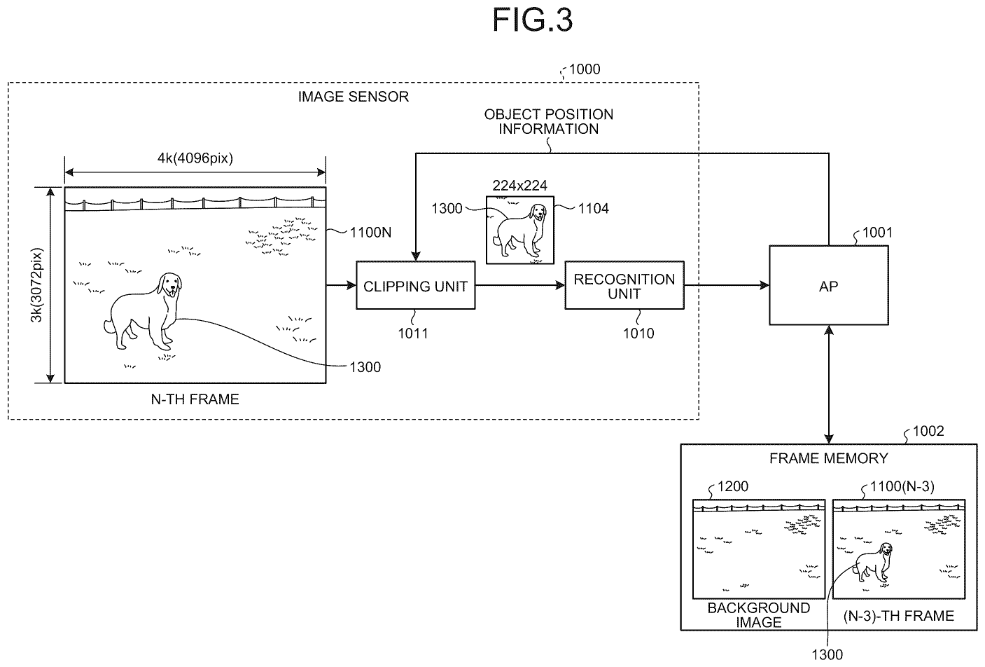

FIG. 2 is a schematic diagram for describing the second image processing method according to the existing technology. In FIG. 2, the image sensor 1000 is configured to operate as a slave of an application processor (hereinafter, AP) 1001 and to clip an input image to be input to the recognition unit 1010 from the captured image 1100 according to an instruction from the AP 1001.

That is, the image sensor 1000 delivers the captured image 1100 captured by the imaging unit (not illustrated) to the AP 1001 (Step S1). The AP 1001 detects an object included in the captured image 1100 received from the image sensor 1000, and returns information indicating a position of the detected object to the image sensor 1000 (Step S2). In the example of FIG. 2, the AP 1001 detects an object 1150 from the captured image 1100 and returns information indicating a position of the object 1150 in the captured image 1100 to the image sensor 1000.

The image sensor 1000 clips the object 1150 from the captured image 1100 on the basis of the position information delivered from the AP 1001, and inputs the clipped image of the object 1150 to the recognition unit 1010. The recognition unit 1010 executes recognition processing on the image of the object 1150 clipped from the captured image 1100. The recognition unit 1010 outputs a recognition result for the object 1150 to, for example, the AP 1001 (Step S3).

According to the second image processing method, the image clipped from the captured image 1100 holds detailed information in the captured image 1100. Since the recognition unit 1010 executes the recognition processing on the image in which the detailed information is held, it is possible to output a recognition result 1151 at a higher recognition rate.

On the other hand, since the AP 1001 executes object position detection processing in the second image processing method, a delay time (latency) from when the captured image is acquired by the image sensor 1000 to when the recognition unit 1010 outputs the recognition result 1151 increases.

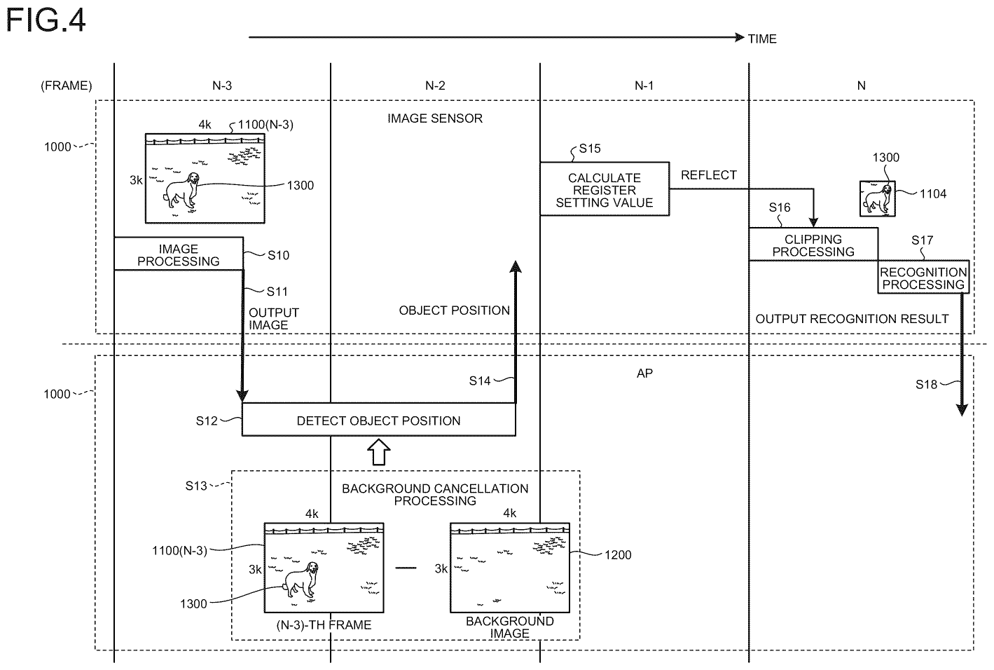

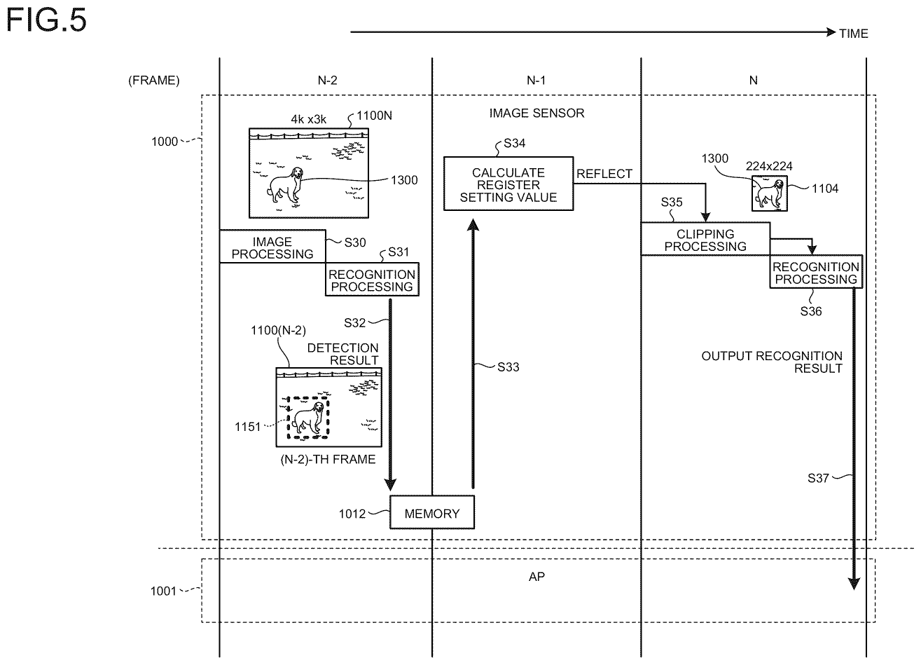

The second image processing method will be described more specifically with reference to FIGS. 3 and 4. FIG. 3 is a functional block diagram of an example for describing functions of the image sensor 1000 configured to execute the second image processing method according to the existing technology. In FIG. 3, the image sensor 1000 includes a clipping unit 1011 and the recognition unit 1010. Note that an imaging unit that captures a captured image 1100N will be omitted in the example of FIG. 3.

The captured image 1100N of the N-th frame is input to the clipping unit 1011. Here, the captured image 1100N is a 4 k×3 k image having 4096 pixels in width and 3072 pixels in height. The clipping unit 1011 clips a region including an object 1300 (in this example, a dog) from the captured image 1100N according to position information delivered from the AP 1001.

That is, the AP 1001 detects the object 1300 using a background image 1200 and a captured image 1100 (N−3) of the (N−3)-th frame stored in a frame memory 1002. More specifically, the AP 1001 stores the captured image 1100(N−3) of the (N−3)-th frame, three frames before the N-th frame, in the frame memory 1002, obtains a difference between the captured image 1100(N−3) and the background image 1200 stored in advance in the frame memory 1002, and detects the object 1300 on the basis of the difference.

The AP 1001 delivers the position information indicating a position of the object 1300 detected from the captured image 1100(N−3) of the (N−3)-th frame in this manner to the image sensor 1000. The image sensor 1000 delivers the position information having been delivered from the AP 1001 to the clipping unit 1011. The clipping unit 1011 clips a recognition image 1104 for the recognition unit 1010 to perform recognition processing from the captured image 1100N on the basis of the position information detected from the captured image 1100(N−3) of the (N−3)-th frame. That is, the recognition unit 1010 executes the recognition processing on the captured image 1100N of the N-th frame using the recognition image 1104 clipped on the basis of the information of the captured image 1100(N−3) of the (N−3)-th frame three frames before the N-th frame.

FIG. 4 is a sequence diagram of an example for describing the second image processing method according to the existing technology. In FIG. 4, the horizontal direction indicates the passage of time in units of frames. Furthermore, the vertical direction indicates processing in the image sensor 1000 on the upper side and processing in the AP 1001 on the lower side.

In the (N−3)-th frame, the captured image 1100(N−3) including the object 1300 is captured. Through image processing (Step S10) in the clipping unit 1011, for example, the captured image 1100(N−3) is output (Step S11) from the image sensor 1000 and is delivered to the AP 1001.

As described above, the AP 1001 performs the object position detection processing on the captured image 1100(N−3) delivered from the image sensor 1000 (Step S12). At this time, the AP 1001 stores the captured image 1100(N−3) in the frame memory 1002, obtains the difference from the background image 1200 stored in advance in the frame memory 1002, and executes background cancellation processing of removing a component of the background image 1200 from the captured image 1100(N−3) (Step S13). The AP 1001 performs the object position detection processing on an image from which the background image 1200 has been removed in the background cancellation processing. When the object position detection processing ends, the AP 1001 delivers position information indicating the position of the detected object (for example, the object 1300) to the image sensor 1000 (Step S14).

Here, the AP 1001 executes the background cancellation processing and the object position detection processing directly using the captured image 1100(N−3) having the resolution of 4 k×3 k. Since the number of pixels of the image to be processed is extremely large, these pieces of processing require a long time. In the example of FIG. 4, a timing at which the object position detection processing ends and the position information is output in Step S14 is close to an end of the (N−2)-th frame.

The image sensor 1000 calculates a register setting value for the clipping unit 1011 to clip the image of the region including the object 1300 from the captured image 1100 on the basis of the position information delivered from the AP 10011 (Step S15). In this example, the supply of the position information from the AP 1001 in Step S14 is close to the end of the (N−2)-th frame, and thus, the calculation of the register setting value in Step S15 is executed in a period of the next (N−1)-th frame.

The image sensor 1000 acquires the captured image 1100N of the N-th frame in the next N-th frame. The register setting value calculated in the (N−1)-th frame is reflected in the clipping unit 1011 in this N-th frame. The clipping unit 1011 executes a clipping processing on the captured image 1100N of the N-th frame according to the register setting value, and clips the recognition image 1104 (Step S16). The recognition unit 1010 executes recognition processing on the recognition image 1104 clipped from the captured image 1100N of the N-th frame (Step S17), and outputs a recognition result to, for example, the AP 1001 (Step S18).

In this manner, according to the second image processing method of the existing technology, the captured image 1100(N−3) of the (N−3)-th frame is directly delivered to the AP 1001, and the AP 1001 performs the background cancellation processing and the object position detection processing using the delivered captured image 1100(N−3). Thus, these processes require a long time, and a significant delay time occurs until an object position detection result is applied to the captured image 1100.

### 2-3. Third Image Processing Method According to Existing Technology

Next, the third image processing method according to the existing technology will be described. As described above, the image corresponding to the region including the object to be recognized is clipped from the captured image 1100 to generate the input image to be input to the recognition unit 1010 in the third image processing method. At this time, the image is clipped on the basis of a recognition result of the recognition unit 1010 in the image sensor 1000 without using the AP 1001 in the third image processing method.

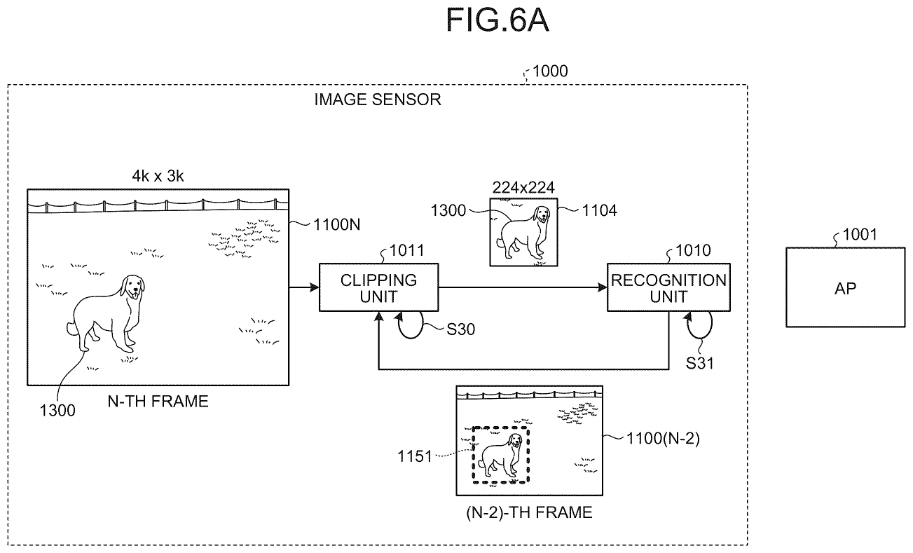

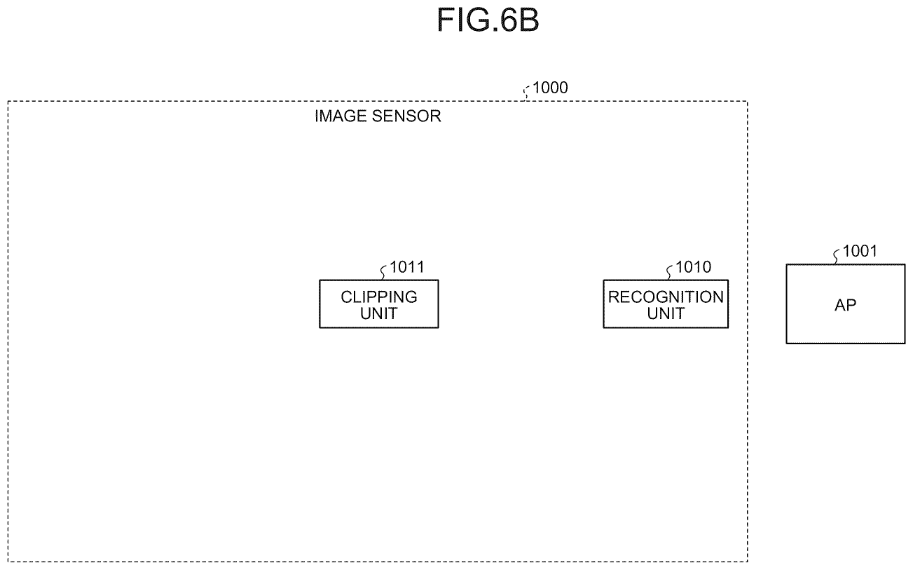

This third image processing method will be described more specifically with reference to FIG. 5 and FIGS. 6A, 6B, and 6C. FIG. 5 is a sequence diagram of an example for describing the third image processing method according to the existing technology. Note that the meaning of each unit in FIG. 5 is similar to that in FIG. 4 described above, and thus, the description thereof will be omitted here. Furthermore, FIGS. 6A, 6B, and 6C are diagrams schematically illustrating states in the image sensor 1000 in processing of each frame in the sequence diagram of FIG. 5.

As illustrated in Frame (N−2) of FIG. 5 and FIG. 6A, a captured image 1100(N−2) including the object 1300 is captured in the (N−2)-th frame. The captured image 1100(N−2) is delivered to the recognition unit 1010 by, for example, image processing (Step S30) in the clipping unit 1011. The recognition unit 1010 performs recognition processing on the captured image 1100(N−2) of the (N−2)-th frame (Step S31). The recognition unit 1010 recognizes and detects a region including the object 1300 by this recognition processing, and outputs information indicating this region as the recognition result 1151 (Step S32). The recognition result 1151 is stored in a memory 1012 included in the image sensor 1000, for example.

As illustrated in Frame (N−1) of FIG. 5 and FIG. 6B, in the next (N−1) frame, the image sensor 1000 obtains an object position in the captured image 1100(N−2), for example, on the basis of the recognition result 1151 stored in the memory 1012 (Step S33), and calculates a register setting value for the clipping unit 1011 to clip an image of a region including the object 1300 from the captured image 1100 on the basis of position information indicating the obtained object position (Step S34).

As illustrated in Frame N of FIG. 5 and FIG. 6C, the image sensor 1000 acquires the captured image 1100N of the N-th frame in the next N-th frame. The register setting value calculated in the (N−1)-th frame is reflected in the clipping unit 1011 in this N-th frame. The clipping unit 1011 executes clipping processing on the captured image 1100N of the N-th frame according to the register setting value, and clips the recognition image 1104 (Step S35). The recognition unit 1010 executes recognition processing on the recognition image 1104 clipped from the captured image 1100N of the N-th frame (Step S36), and outputs a recognition result to, for example, the AP 1001 (Step S37).

In this manner, in the third image processing method, the clipping processing is performed on the captured image 1100N of the N-th frame using the recognition image 1104 obtained by the recognition processing on the captured image 1100(N−2) of the (N−2)-th frame, and a delay of two frames occurs. Moreover, a throughput is also ½ by repeating the object position detection and the object recognition in this manner in the third image processing method, whereas the delay time can be shortened in the third image processing method as compared with the second image processing method described above since the AP 1001 is not used for the clipping processing.

### 2-4. Movement Prediction According to Existing Technology

Next, a case of predicting a movement of the object 1300 moving at a high speed, that is, predicting a future position of the object 1300 in a case where the second or third image processing method described above is used will be described.

As described above, for the captured image 1100N of the N-th frame to be actually clipped, a clipping region is determined on the basis of the captured image 1100(N−2) of the (N−2)-th frame or the captured image 1100(N−3) of the (N−3)-th frame in the existing technology. Thus, when the object 1300 moves at a high speed, there is a possibility that a position of the object 1300 in the captured image 1100N of the N-th frame, which is temporally later than the (N−2)-th or (N−3)-th frame, is greatly different from a position at a point in time when the clipping region has been determined. Therefore, it is preferable that a movement of the object 1300 be predicted using information of a frame temporally earlier than the N-th frame, and a position of the object 1300 in the captured image 1100N of the N-th frame be predicted.

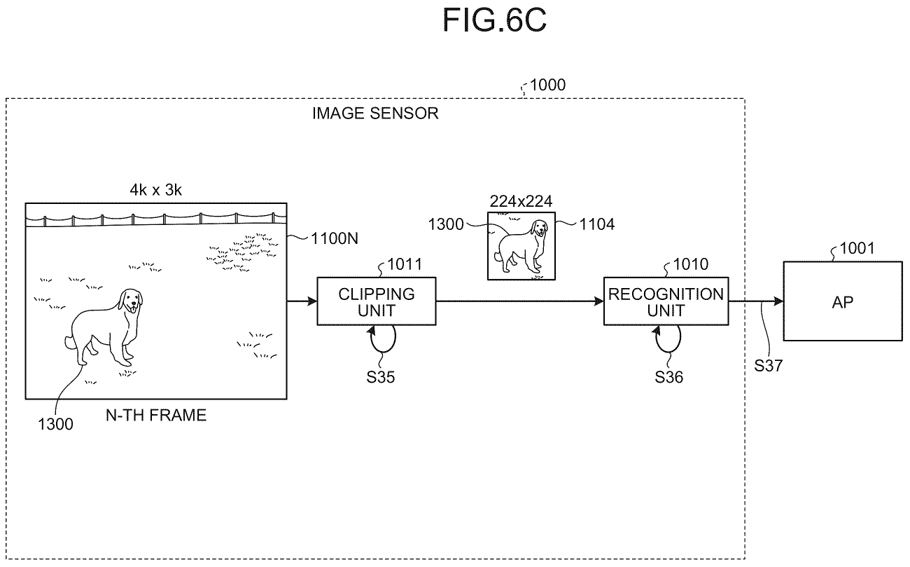

FIG. 7 is a schematic diagram for describing movement prediction according to the existing technology. The example of FIG. 7 schematically illustrates a state in which the respective captured images 1100(N−3) to 1100N of the (N−3)-th to N-th frames are superimposed. In this case, the object 1300 has started from a lower left corner of each of the captured images 1100(N−3) to 1100N, moved with a large curve, and reached a lower right corner from the (N−3)-th frame to the N-th frame as indicated by a trajectory 1401 in the drawing.

In the second and third image processing methods described above, the register setting value to be set for the clipping unit 1011 is calculated for the (N−1)-th frame as illustrated in FIGS. 4 and 6. Thus, the captured image 1100(N−1) of the (N−1)-th frame immediately before the N-th frame is not used for the movement prediction of the object 1300. Thus, for example, when the movement of the object 1300 is predicted on the basis of the captured images 1100(N−3) and 1100 (N−2) of the (N−3)-th and (N−2)-th frames temporally before the N-th frame, there is a possibility that a trajectory significantly different from the actual trajectory 1401 is predicted as indicated by a trajectory 1400 in FIG. 7. According to the trajectory 1400, the object 1300 is predicted to be located near the upper right of the captured image 1100N of the N-th frame at a point in time of the N-th frame, and this is greatly different from the actual position (lower right corner).

Therefore, the object 1300 does not exist at the predicted position at the point in time of the N-th frame, and the object 1300 does not exist in a clipped region even if the captured image 1100N is clipped on the basis of the predicted position, and thus, it is difficult for the recognition unit 1010 to correctly recognize the object 1300.

### 3. Configuration Applicable to Each Embodiment of Present Disclosure

Next, a configuration applicable to each of the embodiments of the present disclosure will be described.

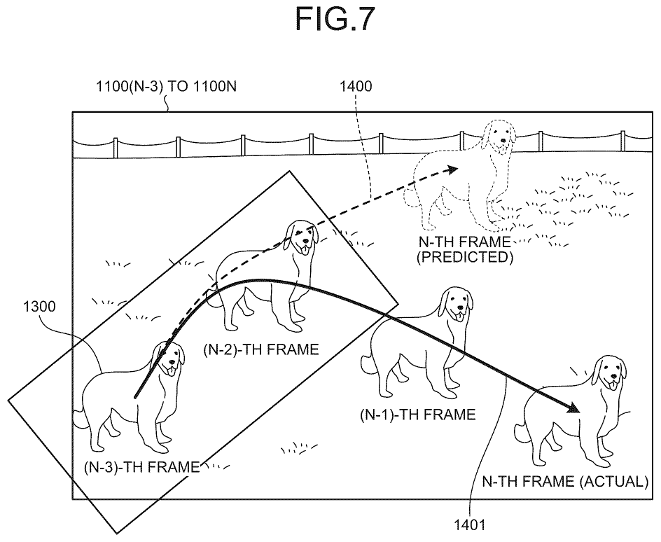

FIG. 8 is a diagram illustrating a configuration of an example of an imaging system applicable to each of the embodiments of the present disclosure. In FIG. 8, an imaging system 1 includes an imaging device 10 and an information processing device 11 which are connected to be capable of communicating with each other via a network 2. Although the imaging system 1 including one imaging device 10 is illustrated in the example of the drawing, the imaging system 1 can include a plurality of the imaging devices 10 connected to the information processing device 11 to be capable of communicating via the network 2.

The imaging device 10 is configured to execute imaging and recognition processing according to the present disclosure, and transmits a recognition result based on a captured image to the information processing device 11 via the network 2 together with the captured image. The information processing device 11 is, for example, a server, receives the captured image and the recognition result transmitted from the imaging device 10, and performs storage, display, and the like of the received captured image and recognition result.

The imaging system 1 configured in this manner is applicable to, for example, a monitoring system. In this case, the imaging device 10 is installed at a predetermined position with a fixed imaging range. This is not limited to this example, and the imaging system 1 can also be applied to other applications, or the imaging device 10 can also be used alone.

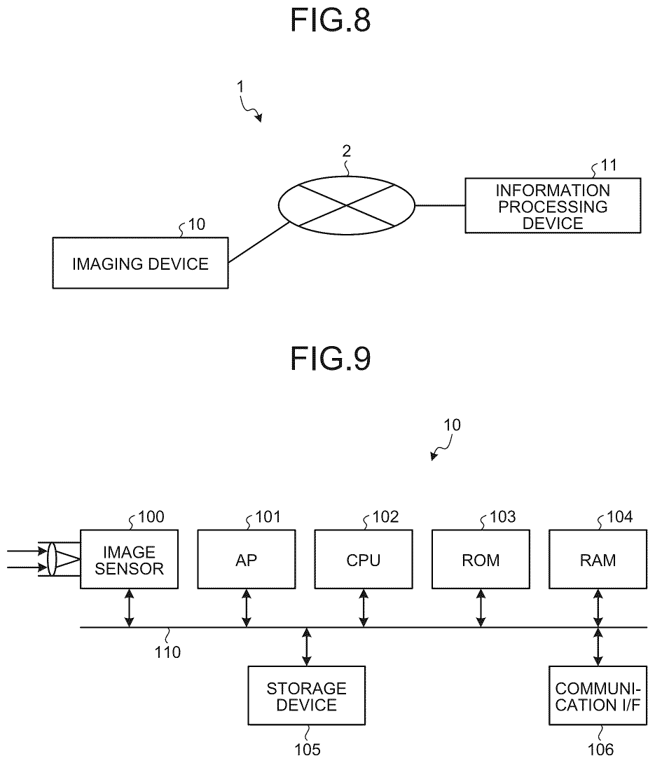

FIG. 9 is a block diagram illustrating a configuration of an example of the imaging device 10 applicable to each of the embodiments. The imaging device 10 includes an image sensor 100, an application processor (AP) 101, a central processing unit (CPU) 102, a read only memory (ROM) 103, a random access memory (RAM) 104, a storage device 105, and a communication I/F 106, and these units are connected to be capable of communicating with each other via a bus 110.

The storage device 105 is a nonvolatile storage medium such as a hard disk drive or a flash memory, and stores programs and various types of data. The CPU 102 operates using the RAM 104 as a work memory according to a program stored in the ROM 103 or the storage device 105, and controls the overall operation of the imaging device 10.

The communication I/F 106 is an interface configured to perform communication with the outside. The communication I/F 106 performs communication via the network 2, for example. Alternatively, the communication I/F 106 may be directly connected to an external device by a universal serial bus (USB) or the like. The communication performed by the communication I/F 106 may be either wired communication or wireless communication.

The image sensor 100 according to each of the embodiments of the present disclosure is a complementary metal oxide semiconductor (CMOS) image sensor configured using one chip, receives incident light from an optical unit, performs photoelectric conversion, and outputs a captured image corresponding to the incident light. Furthermore, the image sensor 100 executes, on the captured image, recognition processing of recognizing an object included in the captured image. The AP 101 executes an application for the image sensor 100. The AP 101 may be integrated with the CPU 102.

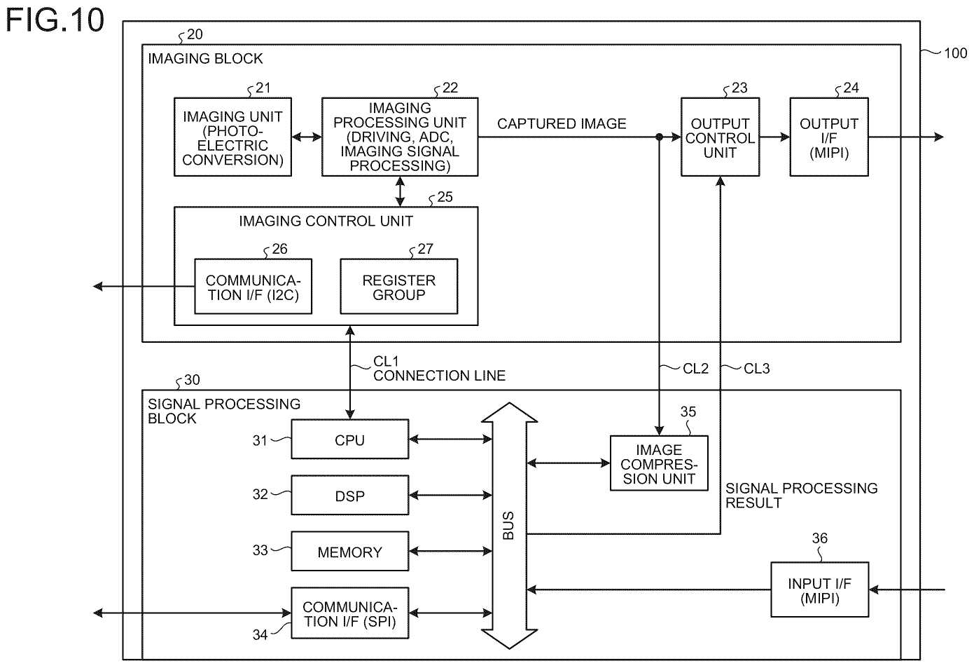

FIG. 10 is a block diagram illustrating a configuration of an example of the image sensor 100 applicable to each of the embodiments of the present disclosure. In FIG. 10, the image sensor 100 includes an imaging block 20 and a signal processing block 30. The imaging block 20 and the signal processing block 30 are electrically connected by connection lines (internal buses) CL1, CL2, and CL3.

The imaging block 20 includes an imaging unit 21, an imaging processing unit 22, an output control unit 23, an output I/F 24, and an imaging control unit 25, and captures an image.

The imaging unit 21 includes a plurality of pixels arrayed two-dimensionally. The imaging unit 21 is driven by the imaging processing unit 22 to capture an image. That is, light from the optical unit is incident on the imaging unit 21. In each of the pixels, the imaging unit 21 receives the incident light from the optical unit, performs photoelectric conversion, and outputs an analog image signal corresponding to the incident light.

Note that a size (resolution) of the image (signal) output by the imaging unit 21 is set to, for example, 4096 pixels in width×3072 pixels in height. This image having 4096 pixels in width×3072 pixels in height is appropriately referred to as a 4 k×3 k image. The size of the captured image output by the imaging unit 21 is not limited to 4096 pixels in width×3072 pixels in height.

Under the control of the imaging control unit 25, the imaging processing unit 22 performs imaging processing related to the image capturing in the imaging unit 21, such as driving of the imaging unit 21, analog to digital (AD) conversion of the analog image signal output from the imaging unit 21, and imaging signal processing. The imaging processing unit 22 outputs a digital image signal, obtained by the AD conversion or the like of the analog image signal output from the imaging unit 21, as the captured image.

Here, examples of the imaging signal processing include processing of obtaining brightness for each small region by calculating an average value of pixel values for each predetermined small region with respect to an image output from the imaging unit 21, processing of converting the image output from the imaging unit 21 into a high dynamic range (HDR) image, defect correction, development, and the like.

The captured image output by the imaging processing unit 22 is supplied to the output control unit 23 and also supplied to an image compression unit 35 of the signal processing block 30 via the connection line CL2.

Not only the captured image supplied from the imaging processing unit 22 but also a signal processing result of signal processing using the captured image and the like is supplied from the signal processing block 30 to the output control unit 23 via the connection line CL3. The output control unit 23 performs output control of selectively outputting the captured image from the imaging processing unit 22 and the signal processing result from the signal processing block 30 to the outside from the (single) output I/F 24. That is, the output control unit 23 selects the captured image from the imaging processing unit 22 or the signal processing result from the signal processing block 30, and supplies the same to the output I/F 24.

The output I/F 24 is an I/F that outputs the captured image and the signal processing result supplied from the output control unit 23 to the outside. For example, a relatively high-speed parallel I/F such as a mobile industry processor interface (MIPI) can be adopted as the output I/F 24.

In the output I/F 24, the captured image from the imaging processing unit 22 or the signal processing result from the signal processing block 30 is output to the outside according to the output control of the output control unit 23. Therefore, for example, in a case where only the signal processing result from the signal processing block 30 is necessary and the captured image itself is unnecessary on the outside, only the signal processing result can be output, and the amount of data output from the output I/F 24 to the outside can be reduced.

Furthermore, signal processing in which a signal processing result required on the outside can be obtained is performed in the signal processing block 30, and the signal processing result is output from the output I/F 24, so that it is not necessary to perform signal processing externally, and a load on an external block can be reduced.

The imaging control unit 25 includes a communication I/F 26 and a register group 27.

The communication I/F 26 is, for example, a first communication I/F such as a serial communication I/F, for example, an inter-integrated circuit (I2C) or the like, and transmits and receives necessary information, such as information to be read from and written to the register 27 group, to and from the outside.

The register group 27 includes a plurality of registers and stores imaging information related to the image capturing by the imaging unit 21 and various types of other information. For example, the register group 27 stores the imaging information received from the outside in the communication I/F 26 and a result (for example, brightness and the like for each small region of the captured image) of the imaging signal processing in the imaging processing unit 22. The imaging control unit 25 controls the imaging processing unit 22 according to the imaging information stored in the register group 27, thereby controlling the image capturing in the imaging unit 21.

Examples of the imaging information stored in the register group 27 include (information indicating) an ISO sensitivity (analog gain at the time of the AD conversion in the imaging processing unit 22), an exposure time (shutter speed), a frame rate, focus, a capturing mode, a clipping range, and the like.

The capturing mode includes, for example, a manual mode in which the exposure time, the frame rate, and the like are manually set, and an automatic mode in which the exposure time, the frame rate, and the like are automatically set according to a scene. Examples of the automatic mode include modes corresponding to various capturing scenes such as a night scene and a human face.

Furthermore, the clipping range represents a range clipped from an image output by the imaging unit 21 in a case where a part of the image output by the imaging unit 21 is clipped and output as a captured image in the imaging processing unit 22. When the clipping range is designated, for example, only a range in which a person appears can be clipped from the image output by the imaging unit 21. Note that, as image clipping, there is a method of reading only an image (signal) in the clipping range from the imaging unit 21 as well as a method of clipping from the image output from the imaging unit 21.

Note that the register group 27 can store output control information regarding the output control in the output control unit 23 in addition to the imaging information and the result of the imaging signal processing in the imaging processing unit 22. The output control unit 23 can perform the output control of selectively outputting the captured image or the signal processing result according to the output control information stored in the register group 27.

Furthermore, in the image sensor 100, the imaging control unit 25 and a CPU 31 of the signal processing block 30 are connected via the connection line CL1, and the CPU 31 can read and write information from and to the register group 27 via the connection line CL1. That is, the reading and writing of information from and to the register group 27 can be performed not only by the communication I/F 26 but also by the CPU 31 in the image sensor 100.

The signal processing block 30 includes a central processing unit (CPU) 31, a digital signal processor (DSP) 32, a memory 33, a communication I/F 34, the image compression unit 35, and an input I/F 36, and performs predetermined signal processing using the captured image or the like obtained by the imaging block 20.

The CPU 31 to the input I/F 36 constituting the signal processing block 30 are connected to each other via a bus, and can transmit and receive information as necessary.

The CPU 31 executes programs stored in the memory 33 to perform control of the signal processing block 30, the reading and writing of information from and to the register group 27 of the imaging control unit 25 via the connection line CL1, and other various processes. For example, by executing a program, the CPU 31 functions as an imaging information calculation unit that calculates imaging information using a signal processing result obtained by signal processing in the DSP 32, and feeds back new imaging information calculated using the signal processing result to the register group 27 of the imaging control unit 25 via the connection line CL1 to be stored. Therefore, as a result, the CPU 31 can control the imaging in the imaging unit 21 and the imaging signal processing in the imaging processing unit 22 according to the signal processing result of the captured image.

Furthermore, the imaging information stored in the register group 27 by the CPU 31 can be provided (output) to the outside from the communication I/F 26. For example, focus information in the imaging information stored in the register group 27 can be provided from the communication I/F 26 to a focus driver (not illustrated) that controls the focus.

By executing a program stored in the memory 33, the DSP 32 functions as a signal processing unit that performs signal processing using the captured image, supplied from the imaging processing unit 22 to the signal processing block 30 via the connection line CL2, and information received by the input I/F 36 from the outside.

The memory 33 is configured using a static random access memory (SRAM), a dynamic RAM (DRAM), and the like, and stores data and the like necessary for processing of the signal processing block 30. For example, the memory 33 stores programs received from the outside by the communication I/F 34, the captured image compressed by the image compression unit 35 and used in the signal processing in the DSP 32, the signal processing result of the signal processing performed in the DSP 32, the information received by the input I/F 36, and the like.

The communication I/F 34 is, for example, a second communication I/F such as a serial communication I/F, for example, a serial peripheral interface (SPI) or the like, and transmits and receives necessary information, such as programs to be executed by the CPU 31 or the DSP 32, to and from the outside (for example, a memory 3, a control unit 6, or the like in FIG. 1). For example, the communication I/F 34 downloads programs to be executed by the CPU 31 or the DSP 32 from the outside, supplies the programs to the memory 33 to be stored. Therefore, various processes can be executed by the CPU 31 or the DSP 32 by the programs downloaded by the communication I/F 34.

Note that the communication I/F 34 can transmit and receive any data as well as the programs to and from the outside. For example, the communication I/F 34 can output the signal processing result obtained by the signal processing in the DSP 32 to the outside. Furthermore, the communication I/F 34 can output information according to an instruction of the CPU 31 to an external device, whereby the external device can be controlled according to the instruction of the CPU 31.

Here, the signal processing result obtained by the signal processing in the DSP 32 can be written into the register group 27 of the imaging control unit 25 by the CPU 31 as well as output from the communication I/F 34 to the outside. The signal processing result written in the register group 27 can be output from the communication I/F 26 to the outside. The same applies to a processing result of processing performed by the CPU 31.

The captured image is supplied from the imaging processing unit 22 to the image compression unit 35 via the connection line CL2. The image compression unit 35 performs compression processing of compressing the captured image as necessary, and generates a compressed image having a smaller amount of data than the captured image. The compressed image generated by the image compression unit 35 is supplied to the memory 33 via the bus and stored therein. The image compression unit 35 can also output the supplied captured image without compressing the captured image.

Here, the signal processing in the DSP 32 can be performed using not only the captured image itself but also the compressed image generated from the captured image by the image compression unit 35. Since the compressed image has a smaller amount of data than the captured image, it is possible to reduce a load of the signal processing in the DSP 32 and to save the storage capacity of the memory 33 that stores the compressed image.

As the compression processing in the image compression unit 35, for example, in a case where the signal processing in the DSP 32 is performed with respect to luminance and the captured image is an RGB image, YUV conversion that converts the RGB image into, for example, a YUV image can be performed as the compression processing. Note that the image compression unit 35 can be achieved by software or can be achieved by dedicated hardware.

The input I/F 36 is an I/F that receives information from the outside. The input I/F 36 receives, for example, an output (external sensor output) of an external sensor from the external sensor, supplies the same to the memory 33 via the bus to be stored.

For example, a parallel I/F such as a mobile industry processor interface (MIPI) can be adopted as the input I/F 36 similarly to the output I/F 24.

Furthermore, as the external sensor, for example, a distance sensor that senses information regarding distance can be adopted. Moreover, as the external sensor, for example, an image sensor that senses light and outputs an image corresponding to the light, that is, an image sensor different from the image sensor 100 can be adopted.

The DSP 32 can perform the signal processing not only using (the compressed image generated from) the captured image but also using the external sensor output received by the input I/F 36 from the external sensor and stored in the memory 33 as described above.

In the one-chip image sensor 100 configured as described above, the signal processing using the captured image obtained by imaging in the imaging unit 21 is performed by the DSP 32, and the signal processing result of the signal processing or the captured image is selectively output from the output I/F 24. Therefore, it is possible to downsize the imaging device that outputs information required by a user.

Here, in a case where the signal processing of the DSP 32 is not performed in the image sensor 100 so that not the signal processing result but the captured image is output from the image sensor 100, that is, in a case where the image sensor 100 is configured as an image sensor that simply captures and outputs an image, the image sensor 100 can be configured only by the imaging block 20 without the output control unit 23.

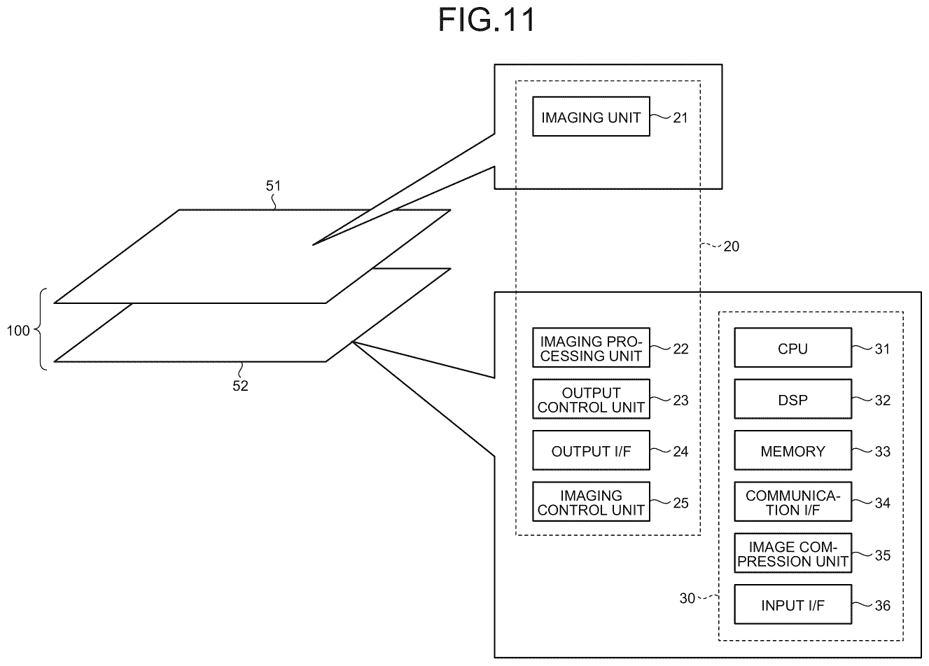

FIG. 11 is a perspective view illustrating an outline of an external configuration example of the image sensor 100 according to each of the embodiments.

For example, as illustrated in FIG. 11, the image sensor 100 can be configured as a one-chip semiconductor device having a stacked structure in which a plurality of dies is stacked. In the example of FIG. 11, the image sensor 100 is configured by stacking two dies of dies 51 and 52.

In FIG. 11, the imaging unit 21 is mounted on the die 51 on the upper side, and the imaging processing unit 22, the output control unit 23, the output I/F 24, the imaging control unit 25, the CPU 31, the DSP 32, the memory 33, the communication I/F 34, the image compression unit 35, and the input I/F 36 are mounted on the die 52 on the lower side.

The die 51 on the upper side and the die 52 on the lower side are electrically connected by, for example, forming a through-hole that penetrates through the die 51 and reaches the die 52, or performing Cu—Cu bonding for directly connecting a Cu wire exposed on a lower surface side of the die 51 and a Cu wire exposed on an upper surface side of the die 52.

Here, as a method for performing AD conversion of an image signal output from the imaging unit 21 in the imaging processing unit 22, for example, a column-parallel AD method or an area AD method can be adopted.

In the column-parallel AD method, for example, an AD converter (ADC) is provided for a column of pixels constituting the imaging unit 21, and the ADC in each column takes charge of AD conversion of pixel signals of pixels in the column, whereby image signals of pixels in the respective columns in one row are subjected to the AD conversion in parallel. In a case where the column-parallel AD method is adopted, a part of the imaging processing unit 22 that performs the AD conversion of the column-parallel AD method may be mounted on the die 51 on the upper side.

In the area AD method, pixels constituting the imaging unit 21 are divided into a plurality of blocks, and an ADC is provided for each block. Then, the ADC of each block takes charge of AD conversion of pixel signals of pixels of the block, whereby image signals of pixels of a plurality of blocks are subjected to the AD conversion in parallel. In the area AD method, the AD conversion (reading and AD conversion) of the image signal can be performed only for necessary pixels among the pixels constituting the imaging unit 21 with the block as the minimum unit.

Note that the image sensor 100 can include one die if the area of the image sensor 100 is allowed to be large.

Furthermore, the two dies 51 and 52 are stacked to form the one-chip image sensor 100 in FIG. 11, but the one-chip image sensor 100 can be configured by stacking three or more dies. For example, in a case where the one-chip image sensor 100 is configured by stacking three dies, the memory 33 of FIG. 11 can be mounted on another die.

### 4. First Embodiment According to Present Disclosure

Next, a first embodiment according to the present disclosure will be described.

### 4-1. Configuration Example According to First Embodiment

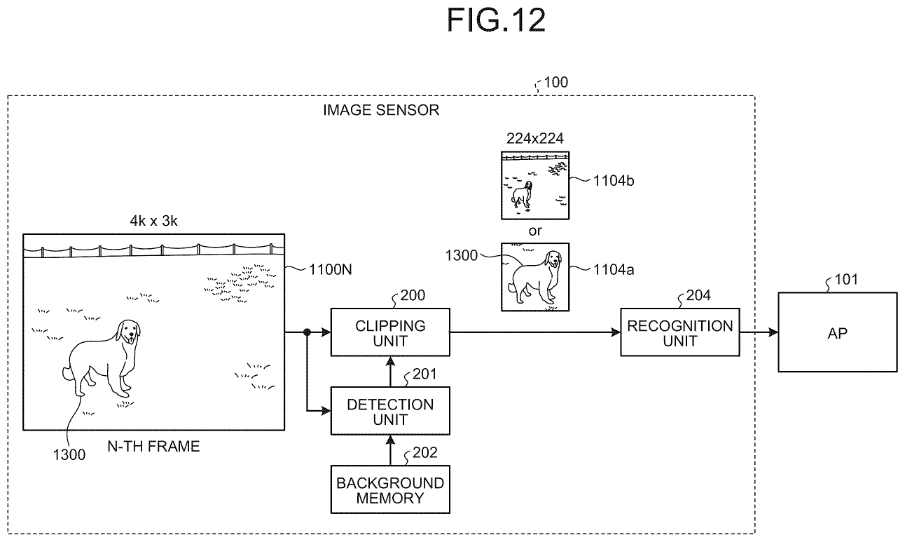

FIG. 12 is a functional block diagram of an example for describing functions of the image sensor 100 according to the first embodiment. In FIG. 12, the image sensor 100 includes a clipping unit 200, a detection unit 201, a background memory 202, and a recognition unit 204. Note that the clipping unit 200, the detection unit 201, the background memory 202, and the recognition unit 204 are achieved by, for example, the DSP 32 in the signal processing block 30 illustrated in FIG. 10.

Imaging is performed in the imaging block 20 (see FIG. 10) (not illustrated), and the captured image 1100N of the N-th frame is output from the imaging block 20. Here, the captured image 1100N is a 4 k×3 k image having 4096 pixels in width×3072 pixels in height.

The captured image 1100N output from the imaging block 20 is supplied to the clipping unit 200 and the detection unit 201.

The detection unit 201 detects a position of the object 1300 included in the captured image 1100N, and delivers position information indicating the detected position to the clipping unit 200. More specifically, the detection unit 201 generates a detection image obtained by lowering a resolution of the captured image 1100N from the captured image 1100N, and detects the position of the object 1300 with respect to the detection image (details will be described later).

Here, the background memory 202 stores in advance a detection background image obtained by changing a background image corresponding to the captured image 1100N to an image having a resolution similar to that of the detection image. The detection unit 201 obtains a difference between an image obtained by lowering the resolution of the captured image 1100N and the detection background image, and uses the difference as the detection image.

Note that, for example, in a case where the imaging device 10 on which the image sensor 100 is mounted is used as a monitoring camera with a fixed imaging range, imaging is performed in a default state in which there is no person or the like in the imaging range, and a captured image obtained therefrom can be applied as the background image. The background image can also be captured according to an operation on the imaging device 10 by the user without being limited thereto.

The clipping unit 200 clips an image including the object 1300 from the captured image 1100N in a predetermined size that can be supported by the recognition unit 204 on the basis of the position information delivered from the detection unit 201, thereby generating a recognition image 1104a. That is, the clipping unit 200 functions as a generation unit that generates a recognition image having a predetermined resolution and including the object 1300 from an input image on the basis of the position detected by the detection unit 201.

Here, the predetermined size that can be supported by the recognition unit 204 is set to 224 pixels in width×224 pixels in height, and the clipping unit 200 clips a region including the object 1300 from the captured image 1100N in the size of 224 pixels in width×224 pixels in height on the basis of the position information to generate the recognition image 1104a. That is, the recognition image 1104a is an image having a resolution of 224 pixels in width×224 pixels in height.

Note that, in a case where a size of the object 1300 does not fall within the predetermined size, the clipping unit 200 can reduce the image clipped from the captured image 1100N including the object 1300 to the size of 224 pixels in width×224 pixels in height to generate the recognition image 1104a. Furthermore, the clipping unit 200 may generate a recognition image 1104b by reducing the entire captured image 1100N to the predetermined size without clipping the captured image 1100N. In this case, the clipping unit 200 can add the position information delivered from the detection unit 201 to the recognition image 1104b.

Note that the following description is given assuming that the clipping unit 200 outputs the recognition image 1104a out of the recognition images 1104a and 1104b.

The recognition image 1104a clipped from the captured image 1100N by the clipping unit 200 is delivered to the recognition unit 204. At this time, the clipping unit 200 can deliver the position information delivered from the detection unit 201 to the recognition unit 204 together with the recognition image 1104a. The recognition unit 204 executes recognition processing of recognizing the object 1300 included in the recognition image 1104 on the basis of a model learned by machine learning, for example. At this time, the recognition unit 204 can apply, for example, a deep neural network (DNN) as the learning model of machine learning. A recognition result of the object 1300 by the recognition unit 204 is delivered to, for example, the AP 101. The recognition result can include, for example, information indicating a type of the object 1300 and a degree of recognition of the object 1300.

Note that the clipping unit 200 can deliver the position information delivered from the detection unit 201 together with the recognition image 1104a when delivering the recognition image 1104a to the recognition unit 204. The recognition unit 204 can acquire a recognition result with higher accuracy by executing recognition processing on the basis of the position information.

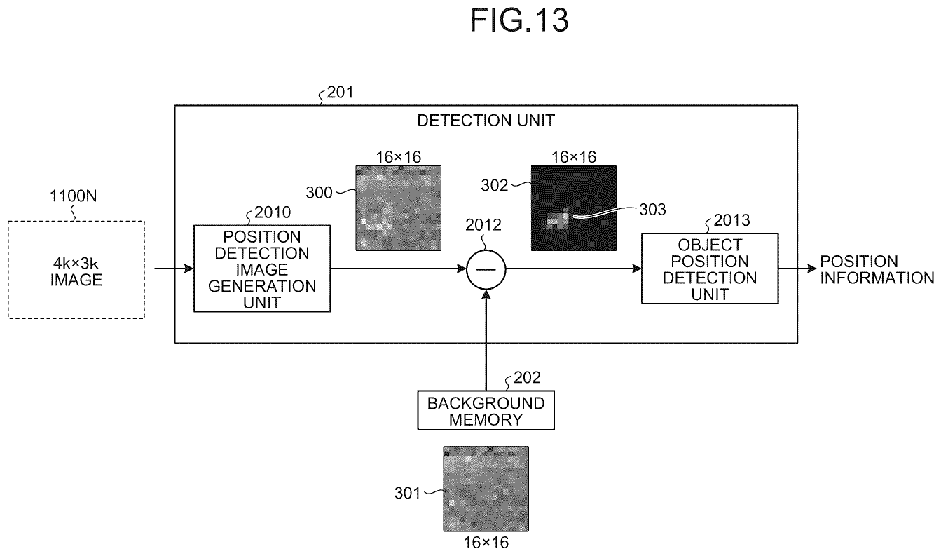

FIG. 13 is a functional block diagram of an example for describing functions of the detection unit 201 according to the first embodiment. In FIG. 13, the detection unit 201 includes a position detection image generation unit 2010, a subtractor 2012, and an object position detection unit 2013.

The position detection image generation unit 2010 generates a low-resolution image 300 obtained by lowering the resolution of the captured image 1100N supplied from the imaging block 20. Here, it is assumed that the low-resolution image 300 generated by the position detection image generation unit 2010 has a resolution (size) of 16 pixels in width×16 pixels in height.

For example, the position detection image generation unit 2010 divides the captured image 1100N into sixteen pieces in each of the width direction and the height direction to be divided to 256 blocks each having a size of 256 pixels (=4096 pixels/16) in width and 192 pixels (=3072 pixels/16) in height. The position detection image generation unit 2010 obtains, for each of the 256 blocks, an integrated value of luminance values of pixels included in the block, normalizes the obtained integrated value, and generates a representative value of the block. The low-resolution image 300 having the resolution (size) of 16 pixels in width×16 pixels in height is generated using the representative values obtained respectively for the 256 blocks as pixel values.

The background cancellation processing is performed on the low-resolution image 300 generated by the position detection image generation unit 2010 using the subtractor 2012 and a low-resolution background image 301 stored in the background memory 202. The low-resolution image 300 is input to a minuend input terminal of the subtractor 2012. A low-resolution background image 301 stored in the background memory 202 is input to a subtrahend input terminal of the subtractor 2012. The subtractor 2012 generates, as a position detection image 302, an absolute value of a difference between the low-resolution image 300 input to the minuend input terminal and the low-resolution background image 301 input to the subtrahend input terminal.

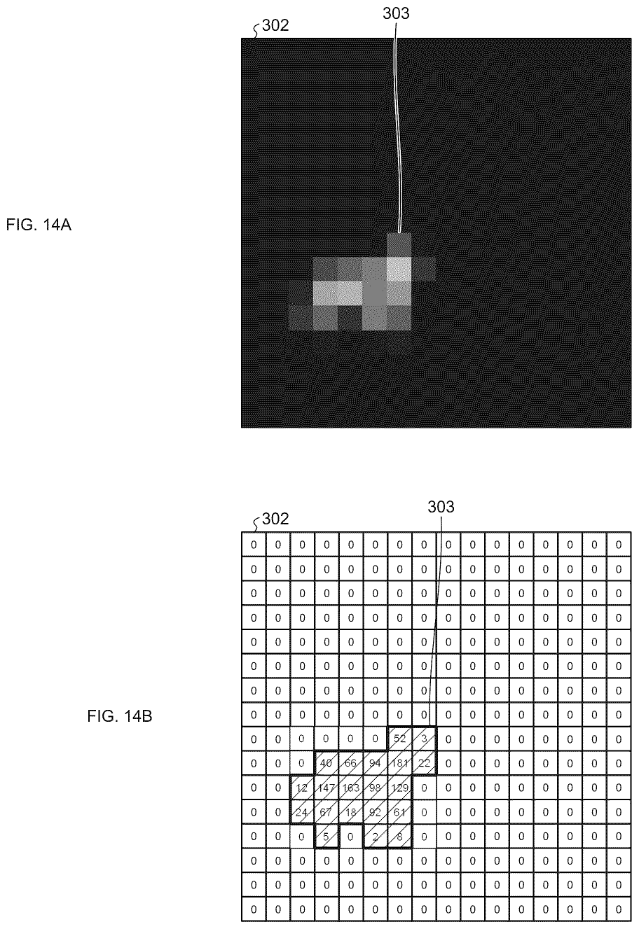

FIG. 14 is a view schematically illustrating an example of the position detection image 302 according to the first embodiment. In FIG. 14, a section (a) illustrates an example of the position detection image 302 as an image. Furthermore, a section (b) illustrates an image of the section (a) using a pixel value of each pixel. Furthermore, in the example of the section (b) in FIG. 14, the pixel value is illustrated on the assumption that a bit depth of the pixel is eight bits.

In a case where pixel values of pixels completely match between a background region of the low-resolution image 300 (a region excluding a low-resolution object region 303 corresponding to the object 1300) and a region of the low-resolution background image 301 corresponding to the background region, the position detection image 302 is obtained such that the background region has a luminance value of a minimum value [0] and the low-resolution object region 303 has a value different from the value [0] as illustrated in the section (b) of FIG. 14.

The position detection image 302 is input to the object position detection unit 2013. The object position detection unit 2013 detects a position of the low-resolution object region 303 in the position detection image 302 on the basis of luminance values of the respective pixels of the position detection image 302. For example, the object position detection unit 2013 performs threshold determination for each of the pixels of the position detection image 302, determines a region of pixels each having a pixel value of [1] or more as the low-resolution object region 303, and obtains a position thereof. Note that a threshold at this time can also have a predetermined margin.

The object position detection unit 2013 can obtain a position of the object 1300 in the captured image 1100N by converting a position of each pixel included in the low-resolution object region 303 into a position of each block obtained by dividing the captured image 1100N (for example, a position of a representative pixel of the block). Furthermore, the object position detection unit 2013 can also obtain a plurality of object positions on the basis of the luminance values of the respective pixels of the position detection image 302.

Position information indicating the position of the object 1300 in the captured image 1100N detected by the object position detection unit 2013 is delivered to the clipping unit 200.

### 4-2. Processing Example According to First Embodiment

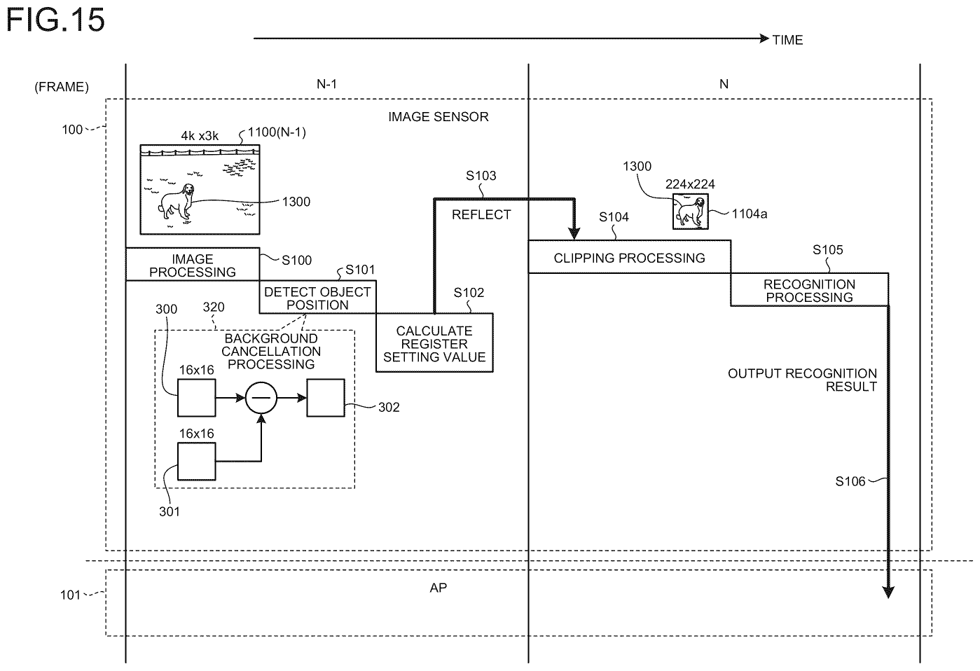

FIG. 15 is a sequence diagram of an example for describing processing according to the first embodiment. Note that the meaning of each unit in FIG. 15 is similar to that in FIG. 4 and the like described above, and thus, the description thereof will be omitted here.

In the (N−1)-th frame, the captured image 1100(N−1) including the object 1300 is captured. The captured image 1100(N−1) is delivered to the detection unit 201 by, for example, image processing (Step S100) in the clipping unit 200, and a position of the object 1300 in the captured image 1100 (N−1) is detected (Step S101). As described above, the position detection in Step S101 is performed on the position detection image 302 obtained by calculating the difference between the low-resolution image 300 and the low-resolution background image 301 each having the size of 16 pixels×16 pixels by background cancellation processing 320.

The image sensor 1000 calculates a register setting value for the clipping unit 200 to clip an image of a region including the object 1300 from the captured image 1100 on the basis of position information indicating the position of the object 1300 in the captured image 1100(N−1) detected by the object position detection processing in Step S101 (Step S102). Here, the number of pixels used for processing is small in the object position detection processing in Step S101, the processing is relatively lightweight, and processing up to the register setting value calculation in Step S102 can be completed within a period of the (N−1)-th frame.

The register setting value calculated in Step S101 is reflected in the clipping unit 200 in the next N-th frame (Step S103). The clipping unit 200 performs clipping processing on the captured image 1100N (not illustrated) of the N-th frame according to the register setting value (Step S104) to generate the recognition image 1104a. The recognition image 1104a is delivered to the recognition unit 204. The recognition unit 204 performs recognition processing on the object 1300 on the basis of the delivered recognition image 1104a (Step S105), and outputs a recognition result to, for example, the AP 101 (Step S106).

In this manner, in the first embodiment, the recognition image 1104a used for the recognition processing by the recognition unit 204 is clipped and generated on the basis of the position of the object 1300 detected using the low-resolution image 300 having a smaller number of pixels of 16 pixels×16 pixels. Thus, the processing up to the register setting value calculation in Step S102 can be completed within the period of the (N−1)-th frame. Thus, a latency until a clipping position is reflected on the captured image 1100N of the N-th frame can be set to one frame, and can be shortened as compared with the existing technology. Furthermore, the object position detection processing and the recognition processing can be executed by different pieces of pipeline processing, and thus, the processing can be performed without lowering a throughput as compared with the existing technology.

### 5. Second Embodiment According to Present Disclosure

Next, a second embodiment of the present disclosure will be described. The second embodiment is an example in which a position of the object 1300 in the captured image 1100N of the N-th frame is predicted using a low-resolution image based on a plurality of the captured images 1100(N−2) and 1100 (N−1) of the (N−2)-th and (N−1)-th frames, for example.

### 5-1. Configuration Example According to Second Embodiment

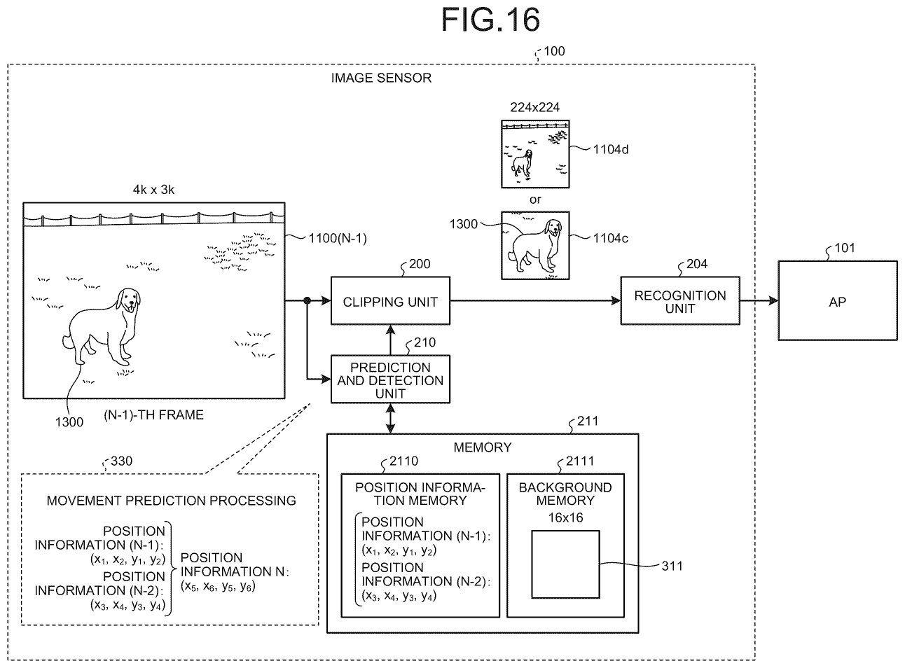

FIG. 16 is a functional block diagram of an example for describing functions of an image sensor according to the second embodiment. The image sensor 100 illustrated in FIG. 16 includes a prediction and detection unit 210 instead of the detection unit 201 and a memory 211 capable of holding at least two pieces of position information as compared with the image sensor 100 according to the first embodiment described with reference to FIG. 12.

Note that the memory 211 can also hold information other than past position information (for example, a past low-resolution image or the like). In the example of FIG. 16, the memory 211 includes a position information memory 2110 configured to hold position information and a background memory 2111 configured to hold a background image 311.

Imaging is performed in the imaging block 20 (see FIG. 10) (not illustrated), and the captured image 1100(N−1) of the (N−1)-th frame, which is a 4 k×3 k image, is output from the imaging block 20. The captured image 1100(N−1) output from the imaging block 20 is supplied to the clipping unit 200 and the prediction and detection unit 210.

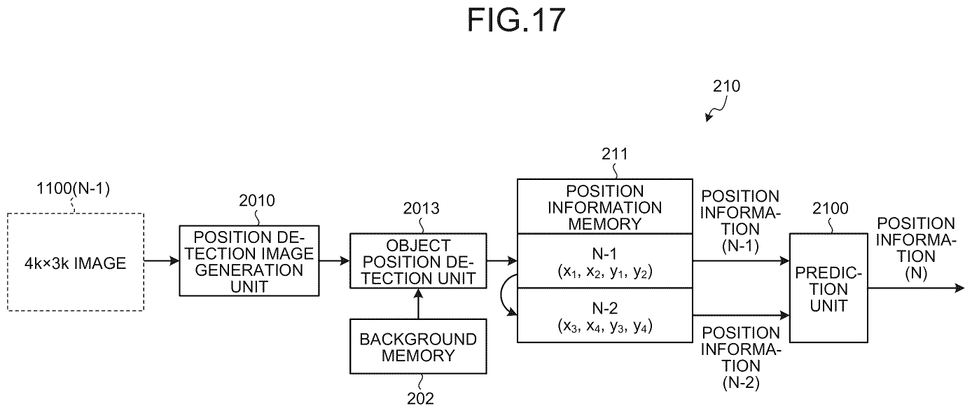

FIG. 17 is a functional block diagram of an example for describing functions of the prediction and detection unit 210 according to the second embodiment. In FIG. 17, the prediction and detection unit 210 includes the position detection image generation unit 2010, the object position detection unit 2013, the position information memory 2110, the background memory 2111, and a prediction unit 2100. Among them, the position detection image generation unit 2010 and the object position detection unit 2013 are similar to the position detection image generation unit 2010 and the object position detection unit 2013 described with reference to FIG. 13, and thus, the detailed description thereof will be omitted here.

The prediction and detection unit 210 detects the low-resolution object region 303 corresponding to the object 1300 from the background image stored in the background memory 2111 and the captured image 1100(N−1) output from the position detection image generation unit 2010. Here, Position information (N−2) is position information indicating a position of the object 1300 generated as described in the first embodiment from the captured image 1100(N−2) of the (N−2)-th frame. Similarly, Position information (N−1) is position information indicating a position of the object 1300 generated from the captured image 1100(N−1) of the (N−1)-th frame.

The processing by the prediction and detection unit 210 will be described in more detail.

In the prediction and detection unit 210, the position information memory 2110 included in the memory 211 can store position information indicating past positions of the object 1300 corresponding to at least two frames.

The position detection image generation unit 2010 generates the low-resolution image 310 obtained by lowering a resolution of the captured image 1100(N−1) including the object 1300 (not illustrated) supplied from the imaging block 20, and outputs the low-resolution image 310 to the object position detection unit 2013.

The object position detection unit 2013 detects a position corresponding to the object 1300. Information indicating the detected position is delivered to the position information memory 2110 as Position information (N−1)=(x₁, x₂, y₁, y₂) in the (N−1)-th frame. In the example of FIG. 17, the position information memory 2110 holds Position information (N−1) delivered from the object position detection unit 2013.

Position information (N−1) indicating the position of the object 1300 is moved to Region (N−2) of the memory 211 at the next frame timing, and Position information (N−2)=(x₃, x₄, y₃, y₄) of the (N−2)-th frame is obtained.

Position information (N−1) in the (N−1)-th frame and Position information (N−2) in the previous frame (the (N−2)-th frame) respectively stored in Region (N−1) and Region (N−2) of the position information memory 2110 are delivered to the prediction unit 2100. The prediction unit 2100 predicts a position of the object 1300 in the captured image 1100N of the N-th frame, which is a future frame, on the basis of Position information (N−1) delivered from the object position detection unit 2013 and Position information (N−2) stored in Region (N−2) of the memory 211.

The prediction unit 2100 can predict the position of the object 1300 in the captured image 1100N of the N-th frame by, for example, a linear operation based on two pieces of Position information (N−1) and Position information (N−2). Furthermore, low-resolution images of past frames can be further stored in the memory 211, and the position can be predicted using three or more pieces of position information. Moreover, it is also possible to determine that a position of the object 1300 is the same object in the respective frames from these low-resolution images. The prediction unit 2100 can also predict the position using a model learned by machine learning without being limited thereto.

The prediction unit 2100 outputs Position information (N) indicating the predicted position of the object 1300 in the captured image 1100N of the N-th frame to, for example, the clipping unit 200.

On the basis of the predicted position information delivered from the prediction and detection unit 210, the clipping unit 200 clips, from the captured image 1100(N−1), an image at the position where the object 1300 is predicted to be included in the captured image 1100N of the N-th frame in a predetermined size (for example, 224 pixels in width×224 pixels in height) that can be supported by the recognition unit 204 to generate a recognition image 1104c.

Note that, in a case where a size of the object 1300 does not fall within the predetermined size, the clipping unit 200 can reduce the image clipped from the captured image 1100 (N−1) including the object 1300 to the size of 224 pixels in width×224 pixels in height to generate the recognition image 1104c. Furthermore, the clipping unit 200 may generate a recognition image 1104d by reducing the entire captured image 1100(N−1) to the predetermined size without clipping the captured image 1100N. In this case, the clipping unit 200 can add the position information delivered from the prediction and detection unit 210 to the recognition image 1104d.

Note that the following description is given assuming that the clipping unit 200 outputs the recognition image 1104c out of the recognition images 1104c and 1104d.

The recognition image 1104c clipped from the captured image 1100(N−1) by the clipping unit 200 is delivered to the recognition unit 204. The recognition unit 204 executes recognition processing of recognizing the object 1300 included in the recognition image 1104c using, for example, a DNN. A recognition result of the object 1300 by the recognition unit 204 is delivered to, for example, the AP 101. The recognition result can include, for example, information indicating a type of the object 1300 and a degree of recognition of the object 1300.

FIG. 17 is a functional block diagram of an example for describing functions of the prediction and detection unit 210 according to the second embodiment. In FIG. 17, the prediction and detection unit 210 includes the position detection image generation unit 2010, the object position detection unit 2013, the background memory 2111, the position information memory 2110, and the prediction unit 2100. Among them, the position detection image generation unit 2010 and the object position detection unit 2013 are similar to the position detection image generation unit 2010 and the object position detection unit 2013 described with reference to FIG. 13, and thus, the detailed description thereof will be omitted here.

The position information memory 2110 can store position information indicating past positions of the object 1300 corresponding to at least two frames.

The position detection image generation unit 2010 generates the low-resolution image 310 obtained by lowering a resolution of the captured image 1100(N−1) including the object 1300 (not illustrated) supplied from the imaging block 20, and outputs the low-resolution image 310 to the object position detection unit 2013.

The object position detection unit 2013 detects a position corresponding to the object 1300. Information indicating the detected position is delivered to the position information memory 2110 as Position information (N−1) in the (N−1)-th frame.

Position information (N−1) indicating the position of the object 1300 is moved to Region (N−2) of the memory 211 at the next frame timing, and Position information (N−2) of the (N−2)-th frame is obtained.

Position information (N−1) in the (N−1)-th frame and Position information (N−2) in the previous frame (the (N−2)-th frame) respectively stored in Region (N−1) and Region (N−2) of the position information memory 2110 are delivered to the prediction unit 2100. The prediction unit 2100 predicts a position of the object 1300 in the captured image 1100N of the N-th frame, which is a future frame, on the basis of Position information (N−1) delivered from the object position detection unit 2013 and Position information (N−2) stored in Region (N−2) of the memory 211.

For example, the prediction unit 2100 can linearly predict a position of the object 1300 in the captured image 1100N of the N-th frame on the basis of two pieces of Position information (N−1) and Position information (N−2). Furthermore, low-resolution images of past frames can be further stored in the memory 211, and the position can be predicted using two or more pieces of position information. Moreover, it is also possible to determine that a position of the object 1300 is the same object in the respective frames from these low-resolution images. Note that the prediction unit 2100 can also predict the position using a model learned by machine learning.

The prediction unit 2100 outputs Position information (N) indicating the predicted position of the object 1300 in the captured image 1100N of the N-th frame to, for example, the clipping unit 200.

### 5-2. Processing Example According to Second Embodiment

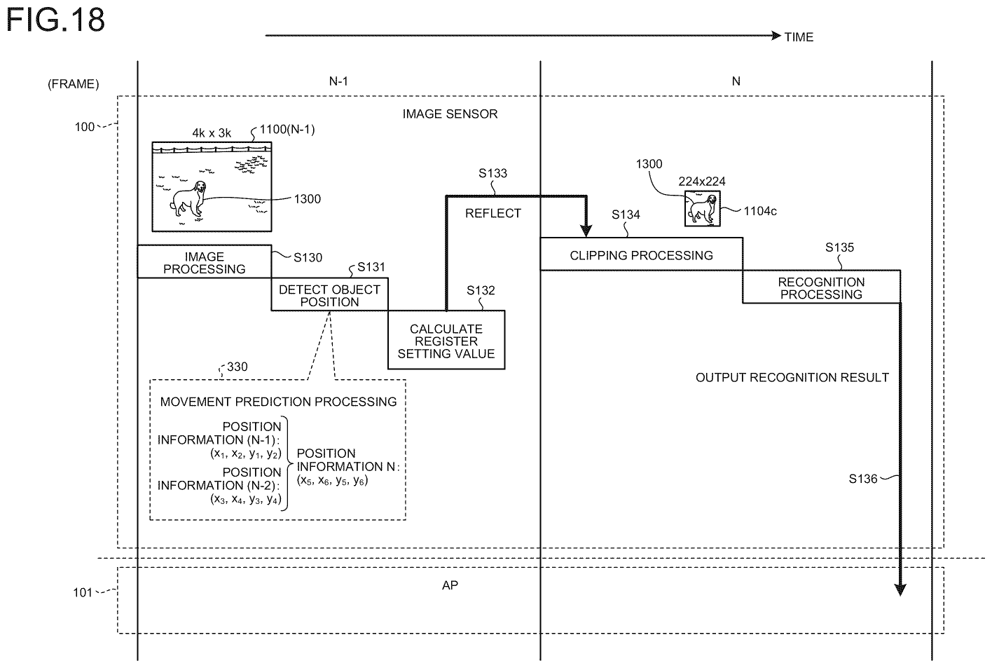

FIG. 18 is a sequence diagram of an example for describing processing according to the second embodiment. Note that the meaning of each unit in FIG. 18 is similar to that in FIG. 4 and the like described above, and thus, the description thereof will be omitted here.

In the (N−1)-th frame, the captured image 1100(N−1) including the object 1300 is captured. Through predetermined image processing (Step S130), the prediction and detection unit 210 predicts a position of the object 1300 in the captured image 1100N of the N-th frame on the basis of two pieces of Position information (N−1) and Position information (N−2) by movement prediction processing 330 described above, and generates Position information (N) indicating the predicted position (Step S131).

The image sensor 1000 calculates a register setting value for the clipping unit 200 to clip an image of a region including the object 1300 from the captured image 1100N on the basis of Position information (N) indicating the future position of the object 1300 in the captured image 1100N predicted by the object position detection processing in Step S131 (Step S132). Here, the number of pixels used for processing is small in the object position detection processing in Step S131, the processing is relatively lightweight, and processing up to the register setting value calculation in Step S132 can be completed within a period of the (N−1)-th frame.

The register setting value calculated in Step S131 is reflected in the clipping unit 200 in the next N-th frame (Step S133). The clipping unit 200 performs clipping processing on the captured image 1100N (not illustrated) of the N-th frame according to the register setting value (Step S144) to generate the recognition image 1104c. The recognition image 1104c is delivered to the recognition unit 204. The recognition unit 204 performs recognition processing on the object 1300 on the basis of the delivered recognition image 1104c (Step S155), and outputs a recognition result to, for example, the AP 101 (Step S136).

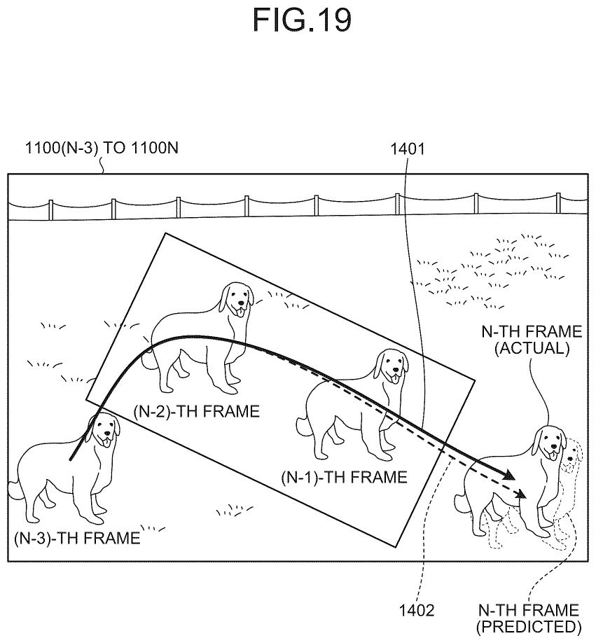

FIG. 19 is a schematic diagram for describing movement prediction according to the second embodiment. Note that the meaning of each unit in FIG. 19 is similar to that in FIG. 7 described above, and thus, the description thereof will be omitted here.

In the second and third image processing methods described with reference to FIG. 7, it is difficult to use the information of the (N−1)-th frame immediately before the N-th frame to predict the position of the object 1300 in the captured image 1100N of the N-th frame. On the other hand, in the second embodiment, the position of the object 1300 in the captured image 1100N of the N-th frame is predicted using the information of the (N−1)-th frame immediately before the N-th frame. Thus, it is possible to predict a trajectory close to the actual trajectory 1401 as indicated by a trajectory 1402 in FIG. 19.

As a result, even in a case where the object 1300 moves at a high speed, the object 1300 included in the captured image 1100N of the N-th frame can be recognized with higher accuracy.

### 5-3. Pipeline Processing Applicable to Second Embodiment

In the processing described with reference to FIG. 18, the object position prediction processing and the recognition processing can be executed by different pieces of pipeline processing, and thus, the processing can be performed without lowering a throughput as compared with the existing technology.

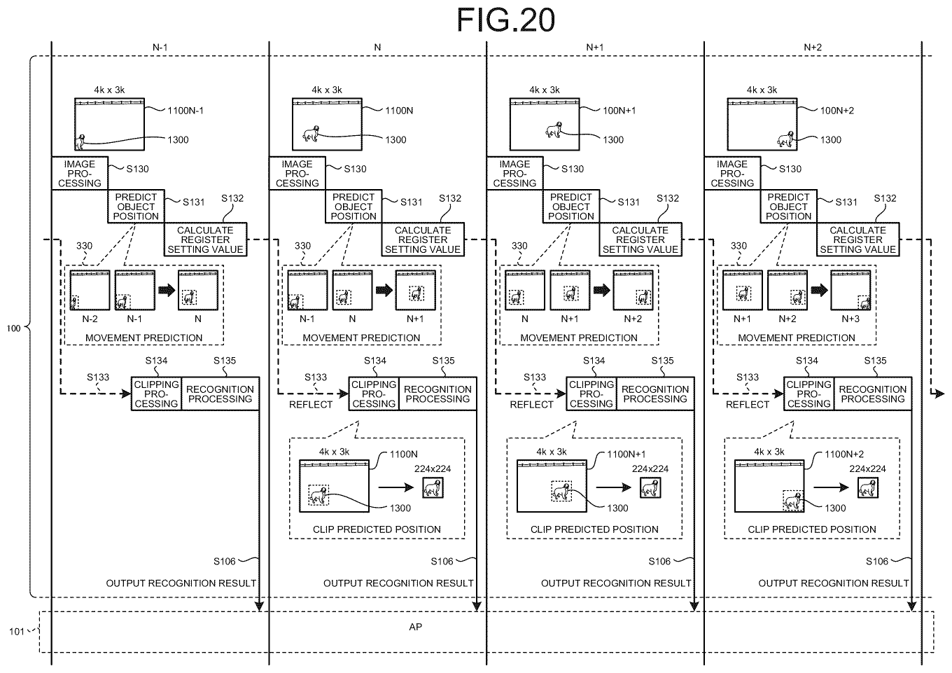

FIG. 20 is a schematic diagram for describing the pipeline processing applicable to the second embodiment. Note that description regarding a part common to FIG. 18 described above will be omitted here.

In FIG. 20, the image sensor 100 executes object position prediction processing (Step S131) based on the captured image 1100N, for example, in the N-th frame as described with reference to FIG. 18. Furthermore, the image sensor 100 executes register setting value calculation processing (Step S132) based on Position information (N) indicating a predicted position. A register setting value calculated here is reflected in clipping processing (Step S134) in the next (N+1)-th frame (Step S133).

On the other hand, in the N-th frame, the image sensor 100 executes clipping processing in the clipping unit 200 (Step S134) using a register setting value calculated in the immediately previous (N−1)-th frame (Step S133) to generate the recognition image 1104c. The recognition unit 204 executes recognition processing on the object 1300 on the basis of the generated recognition image 1104c (Step S135).

The similar processing is repeated in the same manner in the (N+1)-th frame subsequent to the N-th frame, the (N+2)-th frame, and so on.

In the above-described processing, in each frame, the object position prediction processing (Step S131) and the register setting value calculation processing (Step S132) for a captured image captured in the frame are processing independent from the clipping processing (Step S134) and the recognition processing (Step S135) based on a register setting value calculated in the previous frame. Thus, pipeline processing by the object position prediction processing (Step S131) and the register setting value calculation processing (Step S132) and pipeline processing by the clipping processing (Step S134) and the recognition processing (Step S135) can be executed in parallel, and the processing can be performed without lowering the throughput as compared with the existing technology. Note that these pieces of pipeline processing are similarly applicable to the processing according to the first embodiment described with reference to FIG. 15.

### 6. Third Embodiment According to Present Disclosure

Next, a third embodiment of the present disclosure will be described. The third embodiment is an example in which a recognition image from which a background image has been removed is delivered to the recognition unit 204. Since the background image other than an object is removed from the recognition image, the recognition unit 204 can recognize the object with higher accuracy.

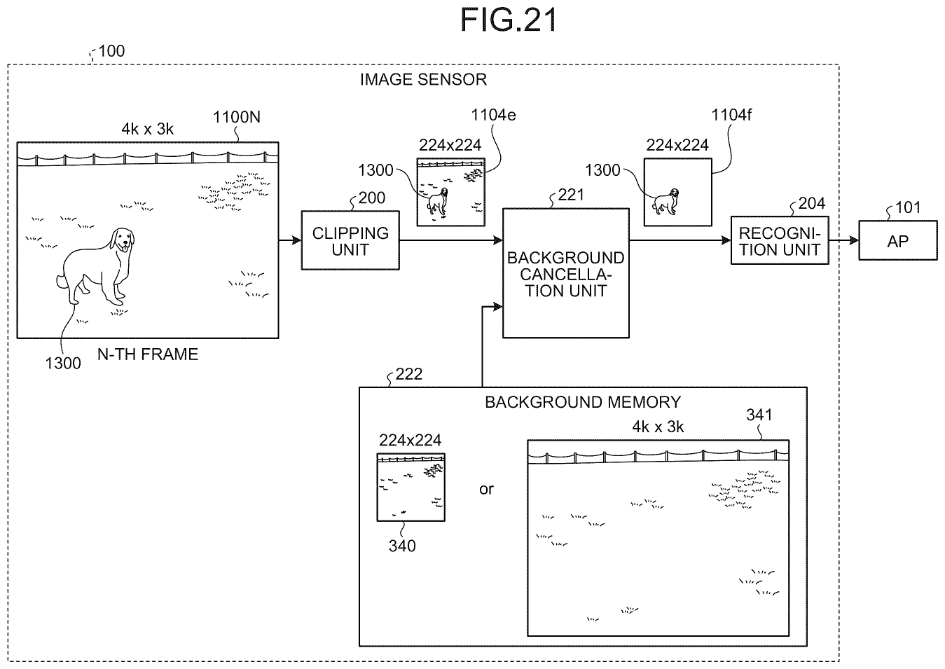

FIG. 21 is a functional block diagram of an example for describing functions of an image sensor according to the third embodiment. The image sensor 100 illustrated in FIG. 21 includes the clipping unit 200, a background cancellation unit 221, a background memory 222, and the recognition unit 204.

Imaging is performed in the imaging block 20 (see FIG. 10) (not illustrated), and the captured image 1100N of the N-th frame, which is a 4 k×3 k image, is output from the imaging block 20. The captured image 1100N output from the imaging block 20 is supplied to the clipping unit 200. The clipping unit 200 reduces the captured image 1100N to a resolution that can be supported by the recognition unit 204, for example, to 224 pixels in width×224 pixels in height to generate a recognition image 1104e. Note that the clipping unit 200 may generate the reduced recognition image 1104e by simply thinning out pixels or by using linear interpolation or the like.

The recognition image 1104e is input to the background cancellation unit 221. A background image 340 having a size of 224 pixels in width×224 pixels in height and previously stored in the background memory 222 is further input to the background cancellation unit 221.

For example, in a case where the imaging device 10 on which the image sensor 100 is mounted is used as a monitoring camera with a fixed imaging range, imaging is performed in a default state in which there is no person or the like in the imaging range, and a captured image obtained therefrom can be applied as the background image 340, which is similar to the description in the first embodiment. The background image can also be captured according to an operation on the imaging device 10 by the user without being limited thereto.

Note that the background image 340 stored in the background memory 222 is not limited to the size of 224 pixels in width×224 pixels in height. For example, a background image 341 having a size of 4 k×3 k which is the same as the captured image 1100N may be stored in the background memory 222. Moreover, the background memory 222 can store a background image of any size from the size of 224 pixels in width×224 pixels in height to the size of 4 k×3 k. For example, in a case where a size of a background image is different from a size of the recognition image 1104e, the background cancellation unit 221 converts the background image into an image having the size of 224 pixels in width×224 pixels in height in association with the recognition image 1104e.

The background cancellation unit 221 uses, for example, the background image 340 having the size of 224 pixels in width×224 pixels in height, similar to that of the recognition image 1104e to obtain absolute values of differences between the recognition image 1104e and the background image 340 input from the clipping unit 200. The background cancellation unit 221 performs threshold determination on the obtained absolute value of the difference for each of the pixels of the recognition image 1104e. The background cancellation unit 221 determines, for example, a region of a pixel having an absolute value of a difference of [1] or more as an object region and determines a region of a pixel having an absolute value of a difference of [0] as a background portion according to a result of the threshold determination, and replaces a pixel value of the pixel of the background portion with a predetermined pixel value (for example, a pixel value indicating white). Note that a threshold at this time can also have a predetermined margin. An image in which the pixel value of the pixel of the background portion has been replaced with the predetermined pixel value is delivered to the recognition unit 204 as a recognition image 1104f obtained by cancelling the background.

The recognition unit 204 can obtain a more accurate recognition result by performing recognition processing on the recognition image 1104f obtained by cancelling the background in this manner. The recognition result by the recognition unit 204 is output to, for example, the AP 101.

### 7. Fourth Embodiment According to Present Disclosure

Next, a fourth embodiment of the present disclosure will be described. The fourth embodiment is a combination of the configurations according to the first to third embodiments described above.

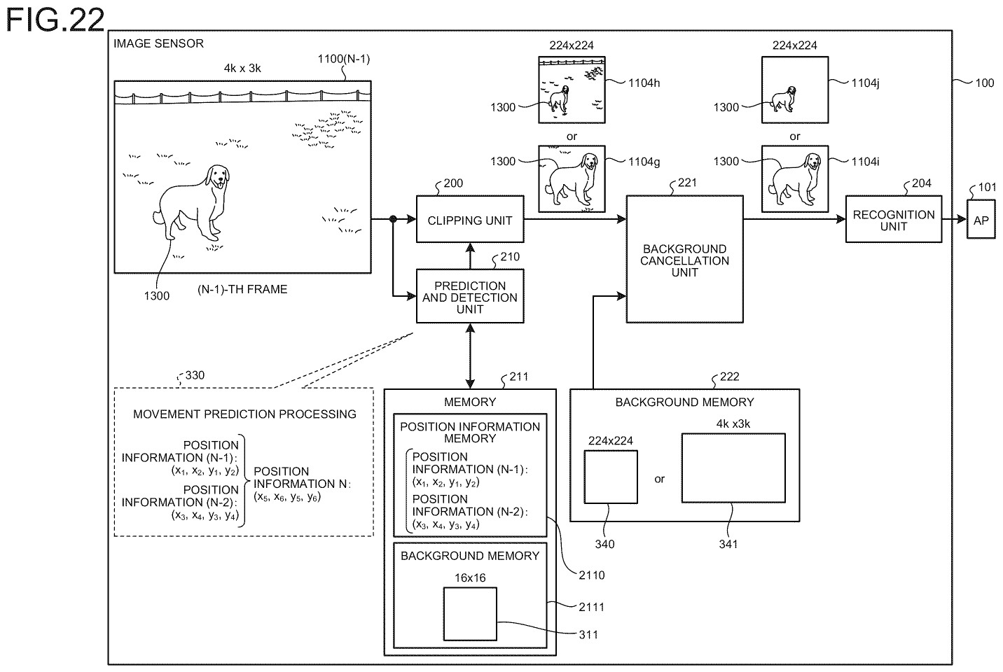

FIG. 22 is a functional block diagram of an example for describing functions of an image sensor according to the fourth embodiment. In FIG. 21, the image sensor 100 includes the clipping unit 200, the prediction and detection unit 210, the background memory 222, the memory 211 including the position information memory 2110 and the background memory 2111, the background cancellation unit 221, and the recognition unit 204. Since functions of these units are similar to the functions described in the first to third embodiments, the detailed description thereof will be omitted here.

Imaging is performed in the imaging block 20 (see FIG. 10) (not illustrated), and the captured image 1100(N−1) of the (N−1)-th frame, which is a 4 k×3 k image, is output from the imaging block 20. The captured image 1100(N−1) output from the imaging block 20 is supplied to the clipping unit 200 and the prediction and detection unit 210.

The prediction and detection unit 210 generates the low-resolution image 300 having 16 pixels in width×16 pixels in height, for example, from the supplied captured image 1100 (N−1) similarly to the position detection image generation unit 2010 described with reference to FIG. 13. Furthermore, the prediction and detection unit 210 obtains a difference between the generated low-resolution image 300 and the low-resolution background image 311 stored in the background memory 2111, and obtains Position information (N−1) of the object 1300. The prediction and detection unit 210 sets Position information (N−1) already stored in the position information memory 2110 of the memory 211 as Position information (N−2) of the (N−2)-th frame, and stores the obtained Position information (N−1) in the position information memory 2110 of the memory 211.

The prediction and detection unit 210 executes the movement prediction processing 330 described with reference to FIG. 17 on the basis of Position information (N−2) and Position information (N−1) stored in the position information memory 2110 of the memory 211, thereby predicting a position of the object 1300 in the captured image 1100N of the N-th frame which is a future frame. The prediction and detection unit 210 generates a low-resolution image 312 including Position information (N) indicating the position predicted in this manner, and delivers the low-resolution image 312 to the clipping unit 200.

On the basis of Position information (N) included in the low-resolution image 312 delivered from the prediction and detection unit 210, the clipping unit 200 clips, from the captured image 1100(N−1), an image at the position where the object 1300 is predicted to be included in the captured image 1100N of the N-th frame, in a predetermined size (for example, 224 pixels in width×224 pixels in height) that can be supported by the recognition unit 204 to generate a recognition image 1104g.

Note that, in a case where a size of the object 1300 does not fall within the predetermined size, the clipping unit 200 can reduce the image clipped from the captured image 1100N including the object 1300 to the size of 224 pixels in width×224 pixels in height to generate the recognition image 1104a. Furthermore, the clipping unit 200 may generate a recognition image 1104h by reducing the entire captured image 1100N to the predetermined size without clipping the captured image 1100N. In this case, the clipping unit 200 can add Position information (N) delivered from the prediction and detection unit 210 to the recognition image 1104h.

For example, the recognition image 1104g output from the clipping unit 200 is input to the background cancellation unit 221. The background image 340 stored in the background memory 222 and having a size corresponding to that of the recognition image 1104g and is further input to the background cancellation unit 221. The background cancellation unit 221 obtains differences between the recognition image 1104g and the background image 340, performs threshold determination of absolute values of the differences respectively pixels of an image of the differences, determines, for example, a region of a pixel having an absolute value of a difference of [1] or more as an object region and a region of a pixel having an absolute value of a difference of [0] as a background portion, and replaces a pixel value of the pixel of the background portion with a predetermined pixel value (for example, a pixel value indicating white). An image in which the pixel value of the pixel of the background portion has been replaced with the predetermined pixel value is delivered to the recognition unit 204 as a recognition image 1104i obtained by cancelling the background. Note that a threshold at this time can also have a predetermined margin.

Note that, in a case where a background image (for example, the background image 341) having a size different from that of the recognition image 1104g is input, the background cancellation unit 221 can convert the background image into an image having a size corresponding to that of the recognition image 1104g. For example, when the recognition image 1104h obtained by reducing the captured image 1100(N−1) is input to the background cancellation unit 221, the background cancellation unit 221 reduces the background image 341 having the same size as the captured image 1100(N−1), and obtains differences between the reduced background image 341 and the recognition image 1104h. The background cancellation unit 221 performs threshold determination on each of pixels of an image of the differences, and determines, for example, a region of a pixel having an absolute value of a difference of [1] or more as an object region and a region of a pixel having an absolute value of a difference of [0] as a background portion. The background cancellation unit 221 replaces a pixel value of the pixel included in the region determined as the background portion with a predetermined pixel value (for example, a pixel value indicating white). An image in which the pixel value of the pixel in the region determined to be the background portion has been replaced with the predetermined pixel value is delivered to the recognition unit 204 as a recognition image 1104j obtained by cancelling the background. Note that a threshold at this time can also have a predetermined margin.

The recognition unit 204 performs recognition processing of the object 1300 on the recognition image 1104i or 1104j obtained by cancelling the background and delivered from the background cancellation unit 221. A result of the recognition processing is output to the AP 101, for example.

The clipping unit 200 clips the recognition image 1104g from the captured image 1100N on the basis of the predicted position. Then, the recognition image 1104i in which the background portion of the recognition image 1104g has been canceled by the background cancellation unit 221 is input to the recognition unit 204.

In the fourth embodiment, the position of the object 1300 in the captured image 1100N of the N-th frame is predicted using an image of, for example, 16 pixels in width×16 pixels in height obtained by reducing a 4 k×3 k image, and thus, the processing can be speeded up, and a latency can be shortened.

Note that effects described in the present specification are merely examples and are not restrictive of the disclosure herein, and other effects not described herein also can be achieved.

Note that the present technology can also have the following configurations.

(1) An image processing device comprising:
a detection unit that detects a position of an object, included in an input image, in the input image;
a generation unit that generates a recognition image having a predetermined resolution and including the object from the input image based on the position detected by the detection unit; and
a recognition unit that performs recognition processing of recognizing the object on the recognition image generated by the generation unit.

(2) The image processing device according to the above (1), wherein
the detection unit
converts the input image having a first resolution into a detection image having a second resolution lower than the first resolution, and detects a position in the input image based on the detection image.

(3) The image processing device according to the above (2), wherein
the predetermined resolution is lower than the first resolution, and the second resolution is lower than the predetermined resolution.

(4) The image processing device according to the above (2) or (3), wherein
the detection unit
uses, as the detection image, a difference between an image, which has the second resolution and is obtained by converting an image corresponding to a case where the input image does not include the object, and an image which has the second resolution and is obtained by converting the input image including the object.

(5) The image processing device according to the above (2), wherein
the detection unit
predicts the position in a future input image with respect to the input image based on the position detected from the input image and the position detected from one or more past input images with respect to the input image.

(6) The image processing device according to the above (5), wherein
the detection unit
includes a memory capable of storing pieces of position information indicating positions of the object corresponding to at least two frames, and
predicts the position in a future input image one frame after the input image based on the position information, detected from a difference between an image, which has the second resolution and is obtained by converting an image corresponding to a case where the input image does not include the object, and the detection image obtained by converting the input image into the image having the second resolution, and the position information one frame before the frame in which the position information is detected.

(7) The image processing device according to any one of the above (1) to (6), wherein
the generation unit
generates the recognition image by clipping a region corresponding to the object from the input image based on the position detected by the detection unit.

(8) The image processing device according to the above (7), wherein
the generation unit
reduces an image of the region to generate the recognition image having the predetermined resolution including a whole of the object when a size of the object in the input image is larger than the predetermined resolution.

(9) The image processing device according to any one of the above (1) to (5), wherein
the generation unit
reduces the input image to an image having the predetermined resolution to generate the recognition image, and delivers the position detected by the detection unit to the recognition unit together with the recognition image.
(10) The image processing device according to any one of the above (1) to (9), further comprising
a background removal unit that removes a background portion of the recognition image and outputs the recognition image from which the background portion has been removed to the recognition unit, wherein
the background removal unit
performs a process of determining the background portion, based on a threshold, on an image generated by subtracting, as an image of the background portion, an image having the predetermined resolution of a region corresponding to the object based on the position in an image corresponding to a case where the input image does not include the object, from an image having the predetermined resolution and including the object generated from the input image by the generation unit based on the position detected by the detection unit, and outputs an image, obtained by replacing a pixel value of a pixel included in a pixel region of the background portion with a predetermined pixel value, to the recognition unit as the recognition image from which the background portion has been removed.

(11) The image processing device according to the above (10), wherein
the background removal unit
includes a background image memory that stores the image of the background portion.

(12) The image processing device according to any one of the above (1) to (11), wherein
the recognition unit
performs recognition of the object based on a model learned by machine learning.

(13) The image processing device according to the above (12), wherein
the recognition unit
performs recognition of the object using a deep neural network (DNN).

(14) An image processing method executed by a processor, the image processing method comprising:
a detection step of detecting a position of an object, included in an input image, in the input image;
a generation step of generating a recognition image having a predetermined resolution and including the object from the input image based on the position detected in the detection step; and
a recognition step of performing recognition processing of recognizing the object on the recognition image generated in the generation step.

### REFERENCE SIGNS LIST

10 IMAGING DEVICE
100 IMAGE SENSOR
101 APPLICATION PROCESSOR
200 CLIPPING UNIT
201 DETECTION UNIT
202, 222, 2111 BACKGROUND MEMORY
204 RECOGNITION UNIT
210 PREDICTION AND DETECTION UNIT
211 MEMORY
221 BACKGROUND CANCELLATION UNIT
222, 2111 BACKGROUND MEMORY
1100, 1100N, 1100(N−1), 1100(N−2), 1100(N−3) CAPTURED IMAGE
1300 OBJECT
1104, 1104a, 1104b, 1104c, 1104d, 1104e, 1104f, 1104g,
1104h, 1104i, 1104j RECOGNITION IMAGE
2110 POSITION INFORMATION MEMORY

1. An image processing device comprising:
a detection unit that detects a position of an object, included in an input image, in the input image;
a generation unit that generates a recognition image having a predetermined resolution and including the object from the input image based on the position detected by the detection unit; and
a recognition unit that performs recognition processing of recognizing the object on the recognition image generated by the generation unit.

2. The image processing device according to claim 1, wherein
the detection unit
converts the input image having a first resolution into a detection image having a second resolution lower than the first resolution, and detects a position in the input image based on the detection image.

3. The image processing device according to claim 2, wherein
the predetermined resolution is lower than the first resolution, and the second resolution is lower than the predetermined resolution.

4. The image processing device according to claim 2, wherein
the detection unit
uses, as the detection image, a difference between an image, which has the second resolution and is obtained by converting an image corresponding to a case where the input image does not include the object, and an image which has the second resolution and is obtained by converting the input image including the object.

5. The image processing device according to claim 2, wherein
the detection unit
predicts the position in a future input image with respect to the input image based on the position detected from the input image and the position detected from one or more past input images with respect to the input image.

6. The image processing device according to claim 5, wherein
the detection unit
includes a memory capable of storing pieces of position information indicating positions of the object corresponding to at least two frames, and
predicts the position in a future input image one frame after the input image based on the position information, detected from a difference between an image, which has the second resolution and is obtained by converting an image corresponding to a case where the input image does not include the object, and the detection image obtained by converting the input image into the image having the second resolution, and the position information one frame before the frame in which the position information is detected.

7. The image processing device according to claim 1, wherein
the generation unit
generates the recognition image by clipping a region corresponding to the object from the input image based on the position detected by the detection unit.

8. The image processing device according to claim 7, wherein
the generation unit
reduces an image of the region to generate the recognition image having the predetermined resolution including a whole of the object when a size of the object in the input image is larger than the predetermined resolution.

9. The image processing device according to claim 1, wherein the generation unit
reduces the input image to an image having the
predetermined resolution to generate the recognition image, and delivers the position detected by the detection unit to the recognition unit together with the recognition image.

10. The image processing device according to claim 1, further comprising
a background removal unit that removes a background portion of the recognition image and outputs the recognition image from which the background portion has been removed to the recognition unit, wherein
the background removal unit
performs a process of determining the background portion, based on a threshold, on an image generated by subtracting, as an image of the background portion, an image having the predetermined resolution of a region corresponding to the object based on the position in an image corresponding to a case where the input image does not include the object, from an image having the predetermined resolution and including the object generated from the input image by the generation unit based on the position detected by the detection unit, and outputs an image, obtained by replacing a pixel value of a pixel included in a pixel region of the background portion with a predetermined pixel value, to the recognition unit as the recognition image from which the background portion has been removed.

11. The image processing device according to claim 10, wherein
the background removal unit
includes a background image memory that stores the image of the background portion.

12. The image processing device according to claim 1, wherein
the recognition unit
performs recognition of the object based on a model learned by machine learning.

13. The image processing device according to claim 12, wherein
the recognition unit
performs recognition of the object using a deep neural network (DNN).

14. An image processing method executed by a processor, the image processing method comprising:
a detection step of detecting a position of an object, included in an input image, in the input image;
a generation step of generating a recognition image having a predetermined resolution and including the object from the input image based on the position detected in the detection step; and
a recognition step of performing recognition processing of recognizing the object on the recognition image generated in the generation step.
